(19) United States
(12) Patent Application Publication
(10) Pub. No.: US 2026/0242544 A1
(43) Pub. Date: Aug. 20, 2026

(54) SILANE AND SILICONE MODIFIED ANTIDEGRADANTS FOR RUBBER AND TIRE

(71) Applicant: Momentive Performance Materials Inc., Niskayuna, NY (US)

(72) Inventors: Yanjun ZHU, Rye Brook, NY (US); Christopher PAPPAS, Charlotte, NC (US); Randy Lun-Yuan FANG, Charlotte, NC (US)

(21) Appl. No.: 19/445,100

(22) Filed: Jan. 9, 2026

Related U.S. Application Data
(60) Provisional application No. 63/743,900, filed on Jan. 10, 2025.

(51) Int. Cl. C08G 77/388; C07F 7/08; C08K 3/04; C08K 3/36; C08K 5/00; C08K 5/36

(52) U.S. Cl. CPC C08G 77/388; C07F 7/081; C08K 3/04; C08K 3/36; C08K 5/0025; C08K 5/36

(57) ABSTRACT

The present disclosure provides silane compounds and silicone polymers, methods of preparing the silane compounds and silicone polymers, and use of the silane compounds and silicone polymers. The present disclosure further provides use of the silane compounds and silicone polymers as antidegradants.

### FIELD OF THE DISCLOSURE

The present disclosure provides silane compounds and silicone polymers, methods of preparing the silane compounds and silicone polymers, and use of the silane compounds and silicone polymers. The present disclosure further provides use of the silane compounds and silicone polymers as antidegradants.

### BACKGROUND

Antidegradants useful in the manufacture of articles formed from elastomers require a very specific combination of properties. An antidegradant must not only have commercially acceptable efficacy but must also exhibit that efficacy over prolonged periods of time particularly when the articles are exposed to degradation from environmental factors such as light, oxygen, and ozone. Thus, an antidegradant must protect the articles formed from the cracking and/or splitting due to these environmental factors.

A commonly used antidegradant in the tire industry is 6PPD (N-(1,3-dimethylbutyl)-N′-phenyl-1,4-benzenediamine), an oxygen and ozone scavenger that migrates to the surface of the tire to protect the tire from cracking and splitting as it wears. However, studies have shown that 6PPD can be converted to 6PPD-quinone during its lifespan, which ultimately finds its way into streams and waterways. 6PPD-quinone has been found to be responsible for killing aquatic and terrestrial organisms (e.g., salmon) in these streams and waterways.

Therefore, there is a need for improved phenylenediamine compounds and polymers that can be used as antidegradants that do not convert to 6PPD-quinone.

### BRIEF SUMMARY OF THE DISCLOSURE

In some aspects, the present disclosure provides a silane compound, wherein the compound is:
(i) a phenylenediamine of Formula (I):

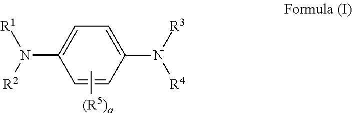

wherein
R¹, R², R³, and R⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, or L₁X₁X₂SiR⁶R⁷R⁸, wherein the heteroatom is N, O, or S;
each R⁵ is independently L₁X₁X₂SiR⁶R⁷R⁸;
a is 0, 1, 2, 3, or 4;
each L₁ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₁ is —C(═O)—, —C(═O)—O—, —C(═O)—N—, or is absent;
X₂ is an optionally substituted alkylene group having from 1 to 20 carbon atoms and optionally at least one heteroatom, wherein the heteroatom is N, O, or S, or is absent;
R⁶, R⁷, and R⁸ are each independently —OR⁹, —R¹⁰, or —OC(═O)R¹¹;
R⁹, R¹⁰, and R¹¹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
wherein at least one of R¹, R², R³, R⁴, and R⁵ is L₁X₁X₂SiR⁶R⁷R⁸; or
(ii) a quinone diimine of Formula (II):

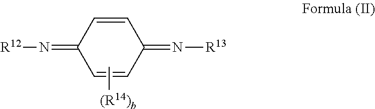

wherein
R¹² and R¹³ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, or L₂X₃X₄SiR¹⁵R¹⁶R¹⁷ wherein the heteroatom is N, O, or S;
each R¹⁴ is independently L₂X₃X₄SiR¹⁵R¹⁶R¹⁷;
b is 0, 1, 2, 3, or 4;
each L₂ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₃ is —C(═O)—, —C(═O)—O—, —C(═O)—N—, or is absent;
X₄ is an optionally substituted alkylene group having from 1 to 20 carbon atoms and optionally at least one heteroatom, wherein the heteroatom is N, O, or S, or is absent;
R¹⁵, R¹⁶, and R¹⁷ are each independently —OR¹⁸, —R¹⁹, or —OC(═O)R²⁰;
R¹⁸, R¹⁹, and R²⁰ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
wherein at least one of R¹², R¹³, and R¹⁴ is L₂X₃X₄SiR¹⁵R¹⁶R¹⁷; or
(iii) a phenylenediamine of Formula (III):

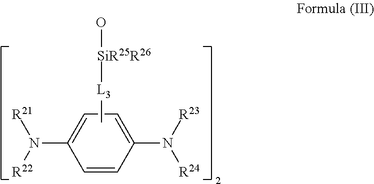

wherein
R²¹, R²², R²³, and R²⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each L₃ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 12 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
R²⁵ and R²⁶ are each independently —OR²⁷, —R²⁸, or —OC(═O)R²⁹; and
R²⁷, R²⁸, and R²⁹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

### BRIEF DESCRIPTION OF THE DRAWINGS

FIG. 1 is a photograph of the prepared rubber composition (Comparative Control A) of Table 17 after testing the physical properties (static results) shown in Table 19.

FIG. 2 is a photograph of the prepared rubber composition (Compound 6) of Table 17 after ozone resistance testing using ASTM D 1149 Method B, Procedure B2.

FIG. 3 is a photograph of the prepared rubber composition (Compound 7) of Table 17 after ozone resistance testing using ASTM D 1149 Method B, Procedure B2.

FIG. 4 is a photograph of the prepared rubber composition (Compound 8) of Table 17 after ozone resistance testing using ASTM D 1149 Method B, Procedure B2.

FIG. 5 is a photograph of the prepared rubber composition (Compound 9) of Table 17 after ozone resistance testing using ASTM D 1149 Method B, Procedure B2.

FIG. 6 is a photograph of the prepared rubber composition (Comparative Control A) of Table 17 after ozone resistance testing using ASTM D 1149 Method A, Procedure A1.

FIG. 7 is a photograph of the prepared rubber composition (Compound 6) of Table 17 after ozone resistance testing using ASTM D 1149 Method A, Procedure A1.

FIG. 8 is a photograph of the prepared rubber composition (Compound 7) of Table 17 after ozone resistance testing using ASTM D 1149 Method A, Procedure A1.

FIG. 9 is a photograph of the prepared rubber composition (Compound 8) of Table 17 after ozone resistance testing using ASTM D 1149 Method A, Procedure A1.

FIG. 10 is a photograph of the prepared rubber composition (Compound 9) of Table 17 after ozone resistance testing using ASTM D 1149 Method A, Procedure A1.

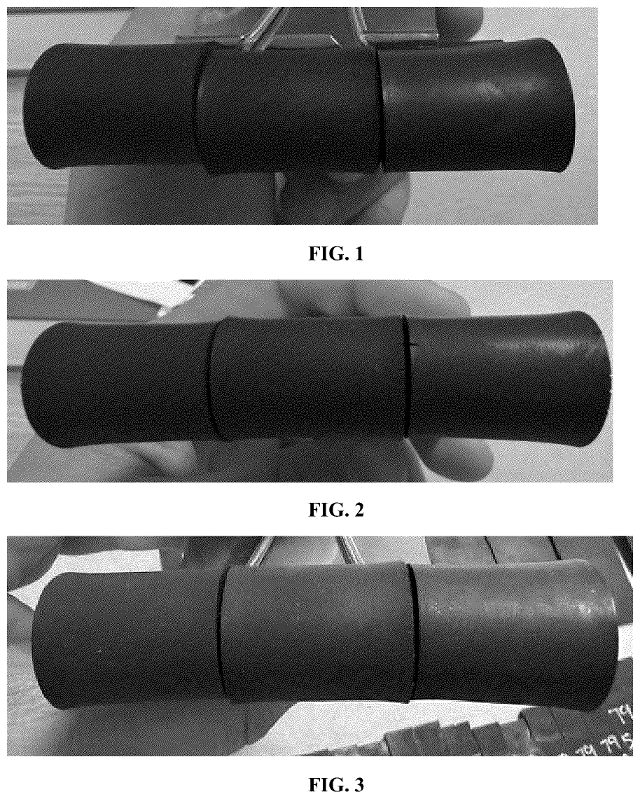

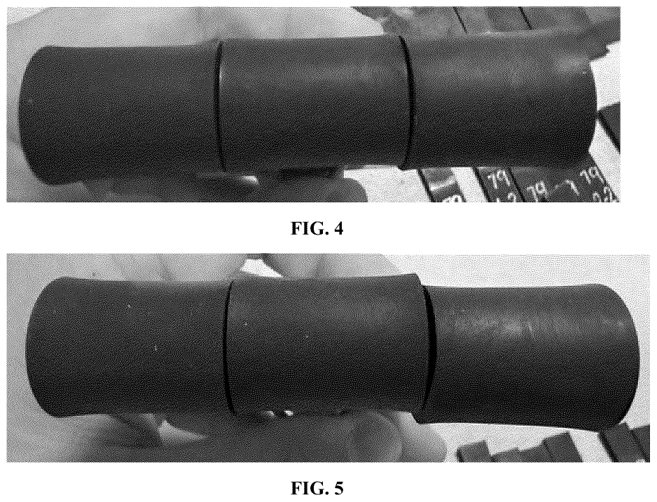

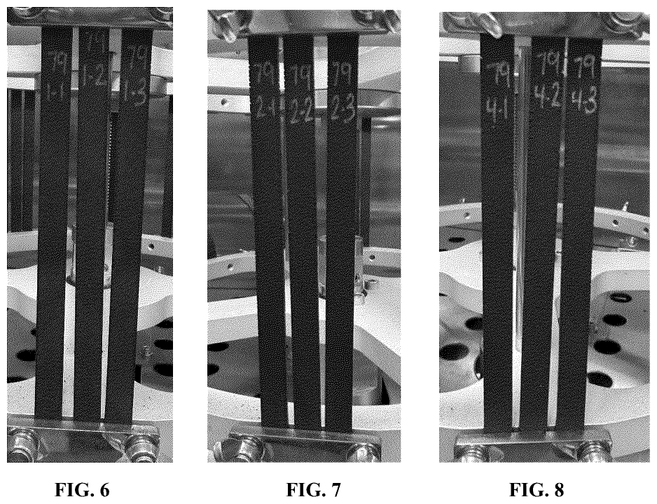

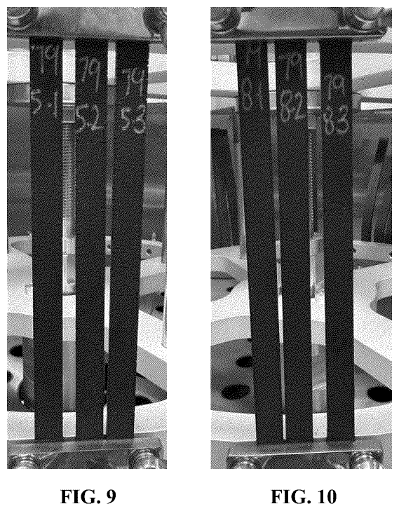

### DETAILED DESCRIPTION

### I. Definitions

As used above, and throughout the description, the following terms, unless otherwise indicated, shall be understood to have the following meanings.

Unless stated otherwise, the terms “a” and “an” and “the” and similar references used in the context of describing a particular aspect of the application (especially in the context of claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

Furthermore, “and/or”, where used herein, is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

It is understood that wherever aspects are described herein with the language “comprising,” otherwise analogous aspects described in terms of “consisting of” and/or “consisting essentially of” are also provided.

The term “polymer” means a substance, chemical compound or mixture of compounds, that has a molecular structure consisting chiefly or entirely of a large number of similar units (e.g., monomer units) bonded together.

The term “about” encompasses the range of experimental error that occurs in any measurement.

The term “antidegradant” means a compound that prevents an elastomer (e.g., rubber) from degrading due to heat, oxygen, ozone, and/or fatigue. The term “elastomer” means a compound that has a great capacity for large elastic deformation under an applied stress. In some aspects, the elastomer is a rubber or a rubber material.

The expression “coupling agent” means an agent that establishes an effective chemical and/or physical bond between two different materials and increases the adhesion between the two materials.

The term “process aid” or “processing aid” as used herein refers to a substance or additive used to soften an elastomer during processing.

The term “silane compound” as used herein refers to a non-polymeric, dimeric or oligomeric silane possessing mercaptan and/or blocked mercaptan functionality and at least one hydroxyalkoxysilyl and/or cyclic dialkoxysilyl group. In some aspects, the silane compound is a dimeric or oligomeric organofunctional silane possessing dialkoxy bridging groups linking adjacent silane units.

The term “siloxane polymer” or “silicone polymer” as used herein is a polymer that has a silicon-oxygen-silicon backbone.

The term, “hydrocarbon” as used herein refers to any chemical structure containing hydrogen atoms and carbon atoms.

The term “optionally substituted” as used herein means that substitution is optional and therefore includes both unsubstituted and substituted atoms and moieties. A “substituted” atom or moiety indicates that any hydrogen on the designated atom or moiety can be replaced with a selected from the indicated substituent groups, provided that the normal valency of the designated atom or moiety is not exceeded, and the that substitution results in a stable compound. For example, if a methyl group is optionally substituted, then 3 hydrogen atoms on the carbon atom can be replaced with substituent groups.

The term “alkyl” means any monovalent, saturated straight chain or branched chain hydrocarbon group; the term “alkenyl” means any monovalent straight chain or branched chain hydrocarbon group containing one or more carbon-carbon double bonds where the site of attachment of the group can be either at a carbon-carbon double bond or elsewhere therein; and, the term “alkynyl” means any monovalent straight chain or branched chain hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein.

Representative examples of alkyls include methyl, ethyl, propyl and isobutyl. Examples of alkenyls include vinyl, propenyl, allyl, methallyl, ethylidenyl norbornane, ethylidene norbornyl, ethylidenyl norbornene and ethylidene norbornenyl. Examples of alkynyls include acetylenyl, propargyl and methylacetylenyl.

The term “cycloalkyl” means any monovalent cyclic aliphatic hydrocarbon group; the term “cycloalkenyl” means any monovalent cyclic aliphatic hydrocarbon group containing one or more carbon-carbon double bonds where the site of attachment of the group can be either at a carbon-carbon double bond or elsewhere therein; and, the term “cycloalkynyl” means any monovalent cyclic aliphatic hydrocarbon group containing one or more carbon-carbon triple bonds and, optionally, one or more carbon-carbon double bonds, where the site of attachment of the group can be either at a carbon-carbon triple bond, a carbon-carbon double bond or elsewhere therein.

Representative examples of cycloalkyl include cyclopropyl, cyclobutyl, cyclopentyl, cyclohexyl, cycloheptyl, cyclooctyl. Examples of cyloalkenyl include cyclopentenyl, cyclohexenyl, cycloheptenyl, cyclooctatrienyl, cyclodecatrienyl, and cyclododecatrienyl. An example of cycloalkynyl is cycloheptynyl.

The terms “cycloalkyl”, “cycloalkenyl”, and “cycloalkynyl” include bicyclic, tricyclic and higher cyclic structures as well as the aforementioned cyclic structures further substituted with alkyl, alkenyl, and/or alkynyl groups. Representative examples include norbornyl, norbornenyl, ethylnorbornyl, ethylnorbornenyl, cyclohexyl, ethylcyclohexyl, and ethylcyclohexenyl.

The term “aryl” includes any aromatic hydrocarbon from which one hydrogen atom has been removed; “aralkyl” includes any of the aforementioned alkyl groups in which one or more hydrogen atoms have been substituted by the same number of like and/or different aryl (as defined herein) substituents; and “arenyl” includes any of the aforementioned aryl groups in which one or more hydrogen atoms have been substituted by the same number of like and/or different alkyl (as defined herein) substituents. Specific, non-limiting examples of aryl groups include phenyl and naphthalenyl. Specific, non-limiting examples of aralkyl groups include phenethyl. Specific, non-limiting examples of arenyl groups include tolyl and xylyl.

The term “alkylene” is a divalent saturated aliphatic radical derived from an alkane by removal of two hydrogen atoms. The term “alkenylene” is a divalent unsaturated aliphatic radical derived from an alkene by removal of four hydrogen atoms.

The term “heteroatom” means an atom of any element other than carbon and includes, for example, oxygen, nitrogen, silicon, sulfur, phosphorus, fluorine, chlorine, bromine, and iodine.

The term “halo” or “halogen” as used by itself or as part of another group refers to —Cl, —F, —Br, or —I. Other than in the working examples or where otherwise indicated, all numbers expressing amounts of materials, reaction conditions, time durations, quantified properties of materials, and so forth, stated in the specification and claims are to be understood as being modified in all instances by the term “about”.

As used herein, the term “filler” refers to a material added to an elastomer (e.g., rubber) formulation to enhance or modify the properties of the final product. The primary purpose of a filler is to improve performance characteristics of an elastomer such as strength, durability, and elasticity compared to an elastomer that does not comprise a filler. A filler can be a reinforcing filler or a non-reinforcing filler.

As used herein, the phrase “reinforcing filler” refers to a filler that improves the properties (e.g., mechanical, electrical, and thermal) of the material it is used in compared to a material that does not comprise a filler. Examples of reinforcing fillers include carbon black, zinc oxide, magnesium carbonate, china clay, ebonite dust, graphite powder, calcium carbonate, lignin, and graphene.

As used herein, the phrase “non-reinforcing filler” refers to a filler than has little or no effect on the properties of the material it is used in compared to the effect on the properties observed on the properties of a material that comprise a reinforcing filler. Examples of non-reinforcing fillers include clay, calcium carbonate, limestone, and oolitic aragonite.

As used herein, the term “oxidizer” refers to a substance that removes electrons (i.e., gains electrons) from another substance during a redox reaction.

It will be understood that any numerical range recited herein includes all sub-ranges with that range and any combination of the various endpoints of such ranges or sub-ranges.

It will be further understood that any compound, material, or substance which is expressly or implicitly disclosed in the specification and/or recited in a claim as belonging to a group of structurally, compositionally and/or functionally related compounds, materials, or substances includes individual representatives of the group and all combinations thereof.

### II. Silane Compounds

The present disclosure provides silane compounds and silicone polymers, methods of preparing the silane compounds and silicone polymers, and use of the silane compounds and silicone polymers. Addition of a silicon group to a compound or polymer as an antidegradant has been found to not only protect the tire from degrading but also to greatly reduce the chance of the antidegradant leaching into the environment due to its affinity to the filler. It is believed that the increased size of the silane compounds and silicone polymers as well as their increased hydrophobicity compared to common antidegradants such as 6PPD assists in reducing the toxicity of the resultant antidegradants which provides a beneficial role in reducing toxicity toward aquatic and terrestrial organisms.

In some aspects, the present disclosure provides a silane compound, wherein the compound is:
(i) a phenylenediamine of Formula (I):

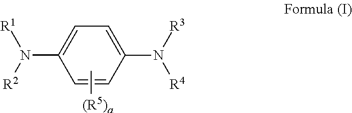

wherein R¹, R², R³, R⁴, R⁵, and a are as defined above.

In some aspects, the silane compound is a phenylenediamine of Formula (IV):

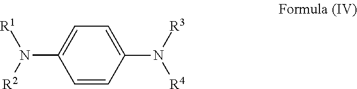

wherein
R¹, R², R³, and R⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, or L₁X₁X₂SiR⁶R⁷R⁸, wherein the heteroatom is N, O, or S;
L₁ is an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₁ is —C(═O)—, —C(═O)—O—, —C(═O)—N—, or is absent;
X₂ is an optionally substituted alkylene group having from 1 to 20 carbon atoms and optionally at least one heteroatom, wherein the heteroatom is N, O, or S, or is absent;
R⁶, R⁷, and R⁸ are each independently —OR⁹, —R¹⁰, or —OC(═O)R¹¹;
R⁹, R¹⁰, and R¹¹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
wherein at least one of R¹, R², R³, or R⁴ is L₁X₁X₂SiR⁶R⁷R⁸.

In some aspects, one of R¹, R², and R³ are hydrogen. In some aspects, two of R¹, R², and R³ are hydrogen. In some aspects, three of R¹, R², and R³ are hydrogen.

In some aspects, one of R¹, R², and R³ is an optionally substituted alkyl group having from 1 to 20 carbon atoms, where the optional substituent is one or more heteroatom. In some aspects, the heteroatom is N, O, or S. In some aspects, two of R¹, R², and R³ is an optionally substituted alkyl group having from 1 to 20 carbon atoms, where the optional substituent is one or more heteroatom. In some aspects, the heteroatom is N, O, or S. In some aspects, three of R¹, R², and R³ is an optionally substituted alkyl group having from 1 to 20 carbon atoms, where the optional substituent is one or more heteroatom. In some aspects, the heteroatom is N, O, or S.

In some aspects, one of R¹, R², and R³ is an optionally substituted aryl group having from 6 to 12 carbon atoms, where the optional substituent is one or more heteroatom. In some aspects, the heteroatom is N, O, or S. In some aspects, two of R¹, R², and R³ is an optionally substituted aryl group having from 6 to 12 carbon atoms, where the optional substituent is one or more heteroatom. In some aspects, the heteroatom is N, O, or S. In some aspects, three of R¹, R², and R³ is an optionally substituted aryl group having from 6 to 12 carbon atoms, where the optional substituent is one or more heteroatom. In some aspects, the heteroatom is N, O, or S.

In some aspects, a is 1. In some aspects, a is 2. In some aspects, a is 3.

In some aspects, L₁ is an optionally substituted alkylene group having from 1 to 20 carbon atoms, where the optional substituent is one or more heteroatom. In some aspects, the heteroatom is N, O, or S.

In some aspects, L₁ is a C₁-C₁₂ alkylene. In some aspects, L₁ is a C₁-C₈ alkylene. In some aspects, L₁ is a C₁-C₄ alkylene. In some aspects, L₁ is a C₃ alkylene. In some aspects, L₁ is —CH₂CH₂—. In some aspects, L₁ is —CH₂CH₂(CH₃)—. In some aspects, L₁ is absent.

In some aspects, X₁ is —C(═O)—. In some aspects, X₁ is —C(═O)—O—. In some aspects, X₁ is —C(═O)—N—. In some aspects, X₁ is absent.

In some aspects, X₂ is an optionally substituted alkylene group having from 1 to 20 carbon atoms, where the optional substituent is one or more heteroatom. In some aspects, the heteroatom is N, O, or S.

In some aspects, X₂ is a C₁-C₂₀ alkylene. In some aspects, X₂ is a C₁-C₁₀ alkylene. In some aspects, X₂ is a C₁-C₅ alkylene. In some aspects, X₂ is methyl.

In some aspects, one of R⁶, R⁷, and R⁸ is —OR⁹. In some aspects, two of R⁶, R⁷, and R⁸ are —OR⁹. In some aspects, three of R⁶, R⁷, and R⁸ are —OR⁹. In some aspects, one of R⁶, R⁷, and R⁸ is —OCH₃. In some aspects, two of R⁶, R⁷, and R⁸ are —OCH₃. In some aspects, three of R⁶, R⁷, and R⁸ are —OCH₃. In some aspects, one of R⁶, R⁷, and R⁸ is —OCH₂CH₃. In some aspects, two of R⁶, R⁷, and R⁸ are —OCH₂CH₃. In some aspects, three of R⁶, R⁷, and R⁸ are —OCH₂CH₃.

In some aspects, one of R⁶, R⁷, and R⁸ is —R¹⁰. In some aspects, two of R⁶, R⁷, and R⁸ are —R¹⁰. In some aspects, three of R⁶, R⁷, and R⁸ are —R¹⁰. In some aspects, one of R⁶, R⁷, and R⁸ is —CH₃. In some aspects, two of R⁶, R⁷, and R⁸ are —CH₃. In some aspects, three of R⁶, R⁷, and R⁸ are —CH₃.

In some aspects, R¹ and R³ are hydrogen and R² is phenyl.

In some aspects, the silane compound of Formula (IV) is selected from the group consisting of:

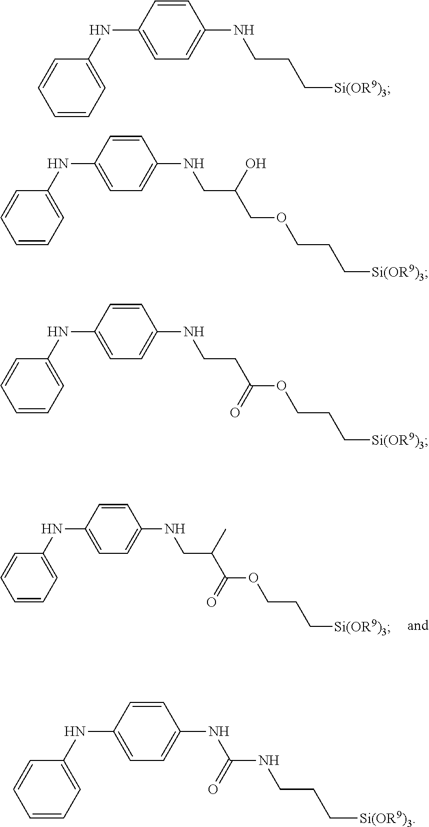

In some aspects, the silane compound is a phenylenediamine of Formula (V):

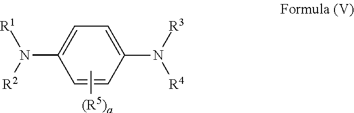

wherein
R¹, R², R³, and R⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each R⁵ is independently L₁X₁X₂SiR⁶R⁷R⁸;
a is 1,2,3, or 4;
each L₁ is independently an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₁ is —C(═O)—, —C(═O)—O—, —C(═O)—N—, or is absent;
X₂ is an optionally substituted alkylene group having from 1 to 20 carbon atoms and optionally at least one heteroatom, wherein the heteroatom is N, O, or S, or is absent;
R⁶, R⁷, and R⁸ are each independently —OR⁹, —R¹⁰, or —OC(═O)R¹¹;
R⁹, R¹⁰, and R¹¹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

In some aspects, one of R¹, R², R³, and R⁴ are hydrogen. In some aspects, two of R¹, R², R³, and R⁴ are hydrogen. In some aspects, three of R¹, R², R³, and R⁴ are hydrogen. In some aspects, four of R¹, R², R³, and R⁴ are hydrogen.

In some aspects, one of R¹, R², R³, and R⁴ is an optionally substituted alkyl group having from 1 to 20 carbon atoms, where the optional substituent is one or more heteroatom. In some aspects, the heteroatom is N, O, or S. In some aspects, two of R¹, R², R³, and R⁴ are an optionally substituted alkyl group having from 1 to 20 carbon atoms, where the optional substituent is one or more heteroatom. In some aspects, the heteroatom is N, O, or S. In some aspects, three of R¹, R², R³, and R⁴ are an optionally substituted alkyl group having from 1 to 20 carbon atoms, where the optional substituent is one or more heteroatom. In some aspects, the heteroatom is N, O, or S.

In some aspects, one of R¹, R², R³, and R⁴ is an optionally substituted aryl group having from 6 to 12 carbon atoms, where the optional substituent is one or more heteroatom. In some aspects, the heteroatom is N, O, or S. In some aspects, two of R¹, R², R³, and R⁴ are an optionally substituted aryl group having from 6 to 12 carbon atoms, where the optional substituent is one or more heteroatom. In some aspects, the heteroatom is N, O, or S. In some aspects, three of R¹, R², R³, and R⁴ are an optionally substituted aryl group having from 6 to 12 carbon atoms, where the optional substituent is one or more heteroatom. In some aspects, the heteroatom is N, O, or S.

In some aspects, L₁ is an optionally substituted alkylene group having from 1 to 20 carbon atoms, where the optional substituent is one or more heteroatom. In some aspects, the heteroatom is N, O, or S.

In some aspects, L₁ is a C₁-C₁₂ alkylene. In some aspects, L₁ is a C₁-C₈ alkylene. In some aspects, L₁ is a C₁-C₄ alkylene. In some aspects, L₁ is a C₃ alkylene. In some aspects, L₁ is —CH₂CH₂(CH₃)—. In some aspects, L₁ is absent.

In some aspects, X₁ is —C(═O)—. In some aspects, X₁ is —C(═O)—O—. In some aspects, X₁ is —C(═O)—N—. In some aspects, X₁ is absent.

In some aspects, X₂ is an optionally substituted alkylene group having from 1 to 20 carbon atoms, where the optional substituent is one or more heteroatom. In some aspects, the heteroatom is N, O, or S.

In some aspects, X₂ is a C₁-C₂₀ alkylene. In some aspects, X₂ is a C₁-C₁₀ alkylene. In some aspects, X₂ is a C₁-C₅ alkyl. In some aspects, X₂ is methyl.

In some aspects, one of R⁶, R⁷, and R⁸ is —OR⁹. In some aspects, two of R⁶, R⁷, and R⁸ are —OR⁹. In some aspects, three of R⁶, R⁷, and R⁸ are —OR⁹. In some aspects, one of R⁶, R⁷, and R⁸ is —OCH₃. In some aspects, two of R⁶, R⁷, and R⁸ are —OCH₃. In some aspects, three of R⁶, R⁷, and R⁸ are —OCH₃. In some aspects, one of R⁶, R⁷, and R⁸ is —OCH₂CH₃. In some aspects, two of R⁶, R⁷, and R⁸ are —OCH₂CH₃. In some aspects, three of R⁶, R⁷, and R⁸ are —OCH₂CH₃.

In some aspects, one of R⁶, R⁷, and R⁸ is —R¹⁰. In some aspects, two of R⁶, R⁷, and R⁸ are —R¹⁰. In some aspects, three of R⁶, R⁷, and R⁸ are —R¹⁰. In some aspects, one of R⁶, R⁷, and R⁸ is —CH₃. In some aspects, two of R⁶, R⁷, and R⁸ are —CH₃. In some aspects, three of R⁶, R⁷, and R⁸ are —CH₃.

In some aspects, R¹ and R³ are hydrogen and R² is phenyl.

In some aspects, the silane compound of Formula (V) is

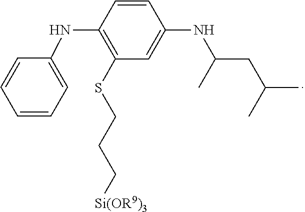

In some aspects, the present disclosure provide a silane compound, wherein the compound is a quinone diimine of Formula (II):

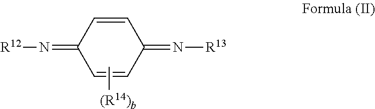

wherein R¹², R¹³, R¹⁴, and b are as defined above.

In some aspects, the silane compound is a quinone diimine of Formula (VI):

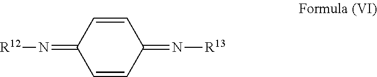

wherein
R¹² and R¹³ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, or L₂X₃X₄SiR¹⁵R¹⁶R¹⁷ wherein the heteroatom is N, O, or S;
each L₂ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₃ is —C(═O)—, —C(═O)—O—, —C(═O)—N—, or is absent;
X₄ is an optionally substituted alkylene group having from 1 to 20 carbon atoms and optionally at least one heteroatom, wherein the heteroatom is N, O, or S, or is absent;
R¹⁵, R¹⁶, and R¹⁷ are each independently —OR¹⁸, —R¹⁹, or —OC(═O)R²⁰.
R¹⁸, R¹⁹, and R²⁰ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
wherein at least one of R¹² and R¹³ is L₂X₃X₄SiR¹⁵R¹⁶R¹⁷.

In some aspects, one of R¹² and R¹³ is hydrogen.

In some aspects, one of R¹² and R¹³ is an optionally substituted alkyl group having from 1 to 20 carbon atoms, where the optional substituent is one or more heteroatom. In some aspects, the heteroatom is N, O, or S. In some aspects, one of R¹² and R¹³ is an optionally substituted aryl group having from 6 to 12 carbon atoms, where the optional substituent is one or more heteroatom. In some aspects, the heteroatom is N, O, or S.

In some aspects, L₂ is an optionally substituted alkylene group having from 1 to 20 carbon atoms, where the optional substituent is one or more heteroatom. In some aspects, the heteroatom is N, O, or S.

In some aspects, L₂ is a C₁-C₁₂ alkylene. In some aspects, L₂ is a C₁-C₈ alkylene. In some aspects, L₂ is a C₁-C₄ alkylene. In some aspects, L₂ is a C₃ alkylene. In some aspects, L₂ is —CH₂CH₂—. In some aspects, L₂ is —CH₂CH₂(CH₃)—. In some aspects, L₂ is absent.

In some aspects, X₃ is —C(═O)—. In some aspects, X₃ is —C(═O)—O—. In some aspects, X₃ is —C(═O)—N—. In some aspects, X₃ is absent.

In some aspects, X₄ is an optionally substituted alkylene group having from 1 to 20 carbon atoms, where the optional substituent is one or more heteroatom. In some aspects, the heteroatom is N, O, or S.

In some aspects, X₄ is a C₁-C₂₀ alkylene. In some aspects, X₄ is a C₁-C₁₀ alkylene. In some aspects, X₄ is a C₁-C₅ alkylene. In some aspects, X₄ is methyl.

In some aspects, one of R¹⁵, R¹⁶, and R¹⁷ is —OR¹⁸. In some aspects, two of R¹⁵, R¹⁶, and R¹⁷ are —OR¹⁸. In some aspects, three of R¹⁵, R¹⁶, and R¹⁷ is —OR¹⁸. In some aspects, one of R¹⁵, R¹⁶, and R¹⁷ is —OCH₃. In some aspects, two of R¹⁵, R¹⁶, and R¹⁷ are —OCH₃. In some aspects, three of R¹⁵, R¹⁶, and R¹⁷ are —OCH₃. In some aspects, one of R⁶, R⁷, and R⁸ is —OCH₂CH₃. In some aspects, two of R¹⁵, R¹⁶, and R¹⁷ are —OCH₂CH₃. In some aspects, three of R¹⁵, R¹⁶, and R¹⁷ are —OCH₂CH₃.

In some aspects, one of R¹⁵, R¹⁶, and R¹⁷ is —R¹⁹. In some aspects, two of R¹⁵, R¹⁶, and R¹⁷ are —R¹⁹. In some aspects, three of R¹⁵, R¹⁶, and R¹⁷ are —R¹⁹. In some aspects, one of R¹⁵, R¹⁶, and R¹⁷ is —CH₃. In some aspects, two of R¹⁵, R¹⁶, and R¹⁷ are —CH₃. In some aspects, three of R¹⁵, R¹⁶, and R¹⁷ are —CH₃.

In some aspects, R¹² is phenyl.

In some aspects, the silane compound of Formula (VI) is

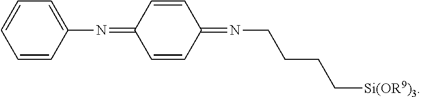

In some aspects, the silane compound is a quinone diimine of Formula (VII):

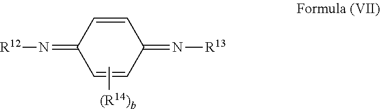

wherein
R¹² and R¹³ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each R¹⁴ is independently L₂X₃X₄SiR¹⁵R¹⁶R¹⁷;
b is 1,2,3, or 4;
each L₂ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₃ is —C(═O)—, —C(═O)—O—, —C(═O)—N—, or is absent;
X₄ is an optionally substituted alkylene group having from 1 to 20 carbon atoms and optionally at least one heteroatom, wherein the heteroatom is N, O, or S, or is absent;
R¹⁵, R¹⁶, and R¹⁷ are each independently —OR¹⁸, —R¹⁹, or —OC(═O)R²⁰;
R¹⁸, R¹⁹, and R²⁰ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

In some aspects, one of R¹² and R¹³ is hydrogen. In some aspects, two of R¹² and R¹³ are hydrogen.

In some aspects, one of R¹² and R¹³ is an optionally substituted alkyl group having from 1 to 20 carbon atoms, where the optional substituent is one or more heteroatom. In some aspects, the heteroatom is N, O, or S. In some aspects, one of R¹² and R¹³ is an optionally substituted aryl group having from 6 to 12 carbon atoms, where the optional substituent is one or more heteroatom. In some aspects, the heteroatom is N, O, or S. In some aspects, two of R¹² and R¹³ are an optionally substituted alkyl group having from 1 to 20 carbon atoms, where the optional substituent is one or more heteroatom. In some aspects, the heteroatom is N, O, or S. In some aspects, two of R¹² and R¹³ are an optionally substituted aryl group having from 6 to 12 carbon atoms, where the optional substituent is one or more heteroatom. In some aspects, the heteroatom is N, O, or S.

In some aspects, b is 1. In some aspects, b is 2. In some aspects, b is 3. In some aspects, b is 4.

In some aspects, L₂ is an optionally substituted alkylene group having from 1 to 20 carbon atoms, where the optional substituent is one or more heteroatom. In some aspects, the heteroatom is N, O, or S.

In some aspects, L₂ is a C₁-C₁₂ alkylene. In some aspects, L₂ is a C₁-C₈ alkylene. In some aspects, L₂ is a C₁-C₄ alkylene. In some aspects, L₂ is a C₃ alkylene. In some aspects, L₂ is —CH₂CH₂—. In some aspects, L₂ is —CH₂CH₂(CH₃)—. In some aspects, L₂ is absent.

In some aspects, X₃ is —C(═O)—. In some aspects, X₃ is —C(═O)—O—. In some aspects, X₃ is —C(═O)—N—. In some aspects, X₃ is absent.

In some aspects, X₄ is an optionally substituted alkylene group having from 1 to 20 carbon atoms, where the optional substituent is one or more heteroatom. In some aspects, the heteroatom is N, O, or S.

In some aspects, X₄ is a C₁-C₂₀ alkylene. In some aspects, X₄ is a C₁-C₁₀ alkylene. In some aspects, X₄ is a C₁-C₅ alkylene. In some aspects, X₄ is methylene.

In some aspects, one of R¹⁵, R¹⁶, and R¹⁷ is —OR¹⁸. In some aspects, two of R¹⁵, R¹⁶, and R¹⁷ are —OR¹⁸. In some aspects, three of R¹⁵, R¹⁶, and R¹⁷ is —OR¹⁸. In some aspects, one of R¹⁵, R¹⁶, and R¹⁷ is —OCH₃. In some aspects, two of R¹⁵, R¹⁶, and R¹⁷ are —OCH₃. In some aspects, three of R¹⁵, R¹⁶, and R¹⁷ are —OCH₃. In some aspects, one of R⁶, R⁷, and R⁸ is —OCH₂CH₃. In some aspects, two of R¹⁵, R¹⁶, and R¹⁷ are —OCH₂CH₃. In some aspects, three of R¹⁵, R¹⁶, and R¹⁷ are —OCH₂CH₃.

In some aspects, one of R¹⁵, R¹⁶, and R¹⁷ is —R¹⁹. In some aspects, two of R¹⁵, R¹⁶, and R¹⁷ are —R¹⁹. In some aspects, three of R¹⁵, R¹⁶, and R¹⁷ are —R¹⁹. In some aspects, one of R¹⁵, R¹⁶, and R¹⁷ is —CH₃. In some aspects, two of R¹⁵, R¹⁶, and R¹⁷ are —CH₃. In some aspects, three of R¹⁵, R¹⁶, and R¹⁷ are —CH₃.

In some aspects, R¹² is phenyl. In some aspects, R¹² is phenyl and R¹³ is hydrogen.

In some aspects, R¹² is phenyl. In some aspects, R¹² is phenyl and R¹³ is —CH(CH₃)CH₂CH₂(CH₃)₂.

In some aspects, the silane compound of Formula (VII) is

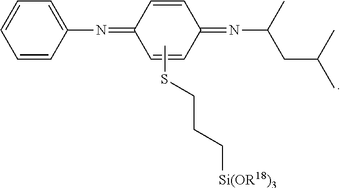

In some aspects, the present disclosure provides a silane compound, wherein the compound is a phenylenediamine of Formula (III):

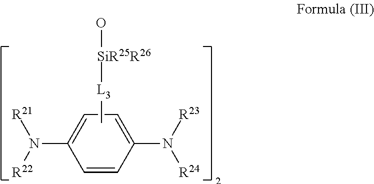

wherein R²¹, R²², R²³, R²⁴, R²⁵, R²⁶, and L₃ are as described above.

In some aspects, one of R²¹, R²², R²³, and R²⁴ is hydrogen. In some aspects, two of R²¹, R²², R²³, and R²⁴ are hydrogen. In some aspects, three of R²¹, R²², R²³, and R²⁴ are hydrogen. In some aspects, four of R²¹, R²², R²³, and R²⁴ are hydrogen.

In some aspects, one of R²¹ and R²³ is an optionally substituted alkyl group having from 1 to 20 carbon atoms, where the optional substituent is one or more heteroatom. In some aspects, one of R²¹ and R²³ is an optionally substituted aryl group having from 6 to 12 carbon atoms, where the optional substituent is one or more heteroatom. In some aspects, two of R²¹ and R²³ are an optionally substituted alkyl group having from 1 to 20 carbon atoms, where the optional substituent is one or more heteroatom. In some aspects, two of R²¹ and R²³ are an optionally substituted aryl group having from 6 to 12 carbon atoms, where the optional substituent is one or more heteroatom. In some aspects, the heteroatom is N, O, or S.

In some aspects, L₃ is an optionally substituted alkylene group having from 1 to 20 carbon atoms, where the optional substituent is one or more heteroatom. In some aspects, the heteroatom is N, O, or S.

In some aspects, L₃ is a C₁-C₁₂ alkylene. In some aspects, L₃ is a C₁-C₈ alkylene. In some aspects, L₃ is a C₁-C₄ alkylene. In some aspects, L₃ is a C₃ alkylene. In some aspects, L₃ is —CH₂CH₂—. In some aspects, L₃ is —CH₂CH₂(CH₃)—.

In some aspects, one of R²⁵ and R²⁶ is —OR²⁷. In some aspects, two of R²⁵ and R²⁶ are —OR²⁷. In some aspects, one of R²⁵ and R²⁶ is —OCH₃. In some aspects, two of R²⁵ and R²⁶ are —OCH₃. In some aspects, one of R²⁵ and R²⁶ is —OCH₂CH₃. In some aspects, two of R²⁵ and R²⁶ are —OCH₂CH₃.

In some aspects, one of R²⁵ and R²⁶ is —R²⁸. In some aspects, two of R²⁵ and R²⁶ are —R²⁸. In some aspects, one of R²⁵ and R²⁶ is —CH₃. In some aspects, two of R²⁵ and R²⁶ are —CH₃.

In some aspects, R²⁵ is phenyl. In some aspects, R²⁵ is phenyl and R²⁶ is hydrogen.

In some aspects, the silane compound is a phenylenediamine of Formula (VIII):

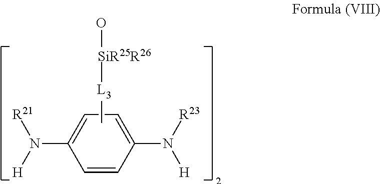

wherein
R²¹ and R²³ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each L₃ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
R²⁵ and R²⁶ are each independently —OR²⁷, —R²⁸, or —OC(═O)R²⁹; and
R²⁷, R²⁸, and R²⁹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

In some aspects, the silane compound of Formula (VIII) is

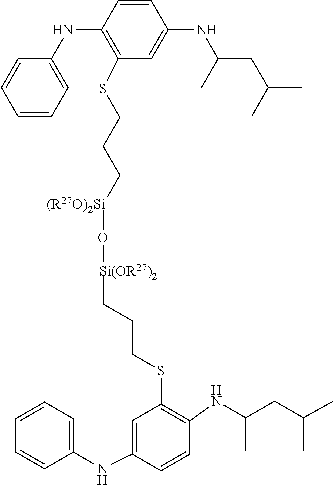

### III. Silicone Polymers

In some aspects, the present disclosure provides a silicone polymer represented by Formula (IX):

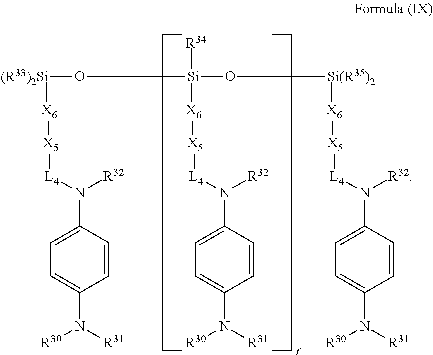

wherein
R³⁰, R³¹, and R³² are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each L₄ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₅ is —C(═O)—, —C(═O)—O—, —C(═O)—N—, or is absent;
X₆ is an optionally substituted alkylene group having from 1 to 20 carbon atoms and optionally at least one heteroatom, wherein the heteroatom is N, O, or S, or is absent;
R³³, R³⁴, and R³⁵ are each independently —OR³⁶, —R³⁷, or —OC(═O)R³⁸; and
R³⁶, R³⁷, and R³⁸ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
f is an integer from 1 to 60.

In some aspects, one of R³⁰, R³¹, and R³² is hydrogen. In some aspects, two of R³⁰, R³¹, and R³² are hydrogen. In some aspects, three of R³⁰, R³¹, and R³² are hydrogen.

In some aspects, one of R³⁰, R³¹, and R³² is an optionally substituted alkyl group having from 1 to 20 carbon atoms, where the optional substituent is one or more heteroatom In some aspects, one of R³⁰, R³¹, and R³² is an optionally substituted aryl group having from 6 to 12 carbon atoms, where the optional substituent is one or more heteroatom. In some aspects, two of R³⁰, R³¹, and R³² are an optionally substituted alkyl group having from 1 to 20 carbon atoms, where the optional substituent is one or more heteroatom. In some aspects, two of R³⁰, R³¹, and R³² are an optionally substituted aryl group having from 6 to 12 carbon atoms, where the optional substituent is one or more heteroatom. In some aspects, three of R³⁰, R³¹, and R³² are an optionally substituted alkyl group having from 1 to 20 carbon atoms, where the optional substituent is one or more heteroatom. In some aspects, three of R³⁰, R³¹, and R³² are an optionally substituted aryl group having from 6 to 12 carbon atoms, where the optional substituent is one or more heteroatom. In some aspects, the heteroatom is N, O, or S.

In some aspects, L₄ is an optionally substituted alkylene group having from 1 to 20 carbon atoms, where the optional substituent is one or more heteroatom. In some aspects, the heteroatom is N, O, or S.

In some aspects, L₄ is a C₁-C₁₂ alkylene. In some aspects, L₄ is a C₁-C₈ alkylene. In some aspects, L₄ is a C₁-C₄ alkylene. In some aspects, L₄ is a C₃ alkylene. In some aspects, L₄ is —CH₂CH₂—. In some aspects, L₄ is —CH₂CH₂(CH₃)—.

In some aspects, X₅ is —C(═O)—. In some aspects, X₅ is —C(═O)—O—. In some aspects, X₅ is —C(═O)—N—. In some aspects, X₅ is absent.

In some aspects, X₆ is an optionally substituted alkylene group having from 1 to 20 carbon atoms, where the optional substituent is one or more heteroatom. In some aspects, the heteroatom is N, O, or S.

In some aspects, X₆ is a C₁-C₂₀ alkylene. In some aspects, X₆ is a C₁-C₁₀ alkylene. In some aspects, X₆ is a C₁-C₅ alkylene. In some aspects, X₆ is methylene.

In some aspects, one of R²⁵ and R²⁶ is —OR²⁷. In some aspects, two of R²⁵ and R²⁶ are —OR²⁷. In some aspects, one of R²⁵ and R²⁶ is —OCH₃. In some aspects, two of R²⁵ and R²⁶ are —OCH₃. In some aspects, one of R²⁵ and R²⁶ is —OCH₂CH₃. In some aspects, two of R²⁵ and R²⁶ are —OCH₂CH₃.

In some aspects, one of R²⁵ and R²⁶ is —R²⁸. In some aspects, two of R²⁵ and R²⁶ are —R²⁸. In some aspects, one of R²⁵ and R²⁶ is —CH₃. In some aspects, two of R²⁵ and R²⁶ are —CH₃.

In some aspects, R²⁵ is phenyl. In some aspects, R²⁵ is phenyl and R²⁶ is hydrogen.

In some aspects, the silicone polymer of Formula (IX) is

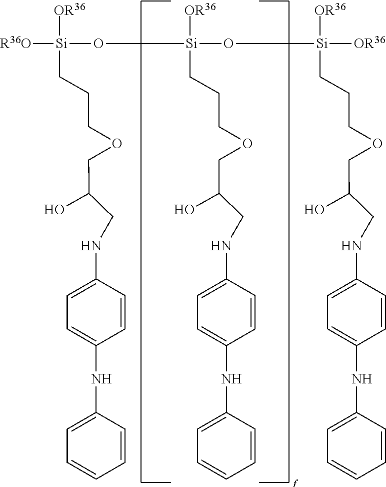

wherein f is an integer from 1 to 60.

### IV. Methods of Making Silane Compounds

In some aspects, the present disclosure provides a method of making a silane compound, wherein the silane compound is the phenylenediamine of Formula (IV):

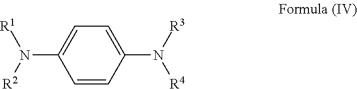

wherein R¹, R², R³, and R⁴ are as described above;

the method comprising reacting a silane compound of Formula (X):

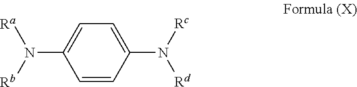

wherein
R^{a}, R^{b}, R^{c}, and R^{d} are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and wherein at least one of R^{a}, R^{b}, R^{c}, and R^{d} is hydrogen;
with a compound of Formula (XI):

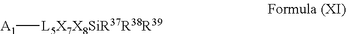

wherein
A₁ is —Cl, —Br, —OH, a glycidoxy group, a methacryloxypropyl group, or an isocyanatopropyl group;
L₅ is an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, wherein the heteroatom is N, O, or S;
X₇ is —C(═O)—, —C(═O)—O—, —C(═O)—N—, or is absent;
X₈ is an optionally substituted alkylene group having from 1 to 20 carbon atoms and optionally at least one heteroatom, wherein the heteroatom is N, O, or S, or is absent;
R³⁷, R³⁸, and R³⁹ are each independently —OR⁴⁰, —R⁴¹, or —OC(═O)R⁴²;
R⁴⁰, R⁴¹, and R⁴² are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

In some aspects, A₁ is —Cl. In some aspects, A₁ is —Br. In some aspects, A₁ is —OH. In some aspects, A₁ is a glycidoxy group. In some aspects, A₁ is a metacryloxypropyl group. In some aspects, A₁ is an isocyanatopropyl group.

In some aspects, the present disclosure provides a method of making a silane compound, wherein the silane compound is a phenylenediamine of Formula (V):

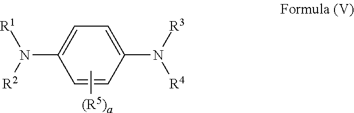

wherein R¹, R², R³, R⁴, R⁵, and a are as described above;
the method comprising reacting a compound of Formula (X):

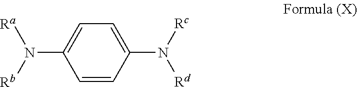

wherein R^{a}, R^{b}, R, and R^{d} are as described above;
with an oxidizer, optionally a catalyst, and at least one compound of Formula (XII):

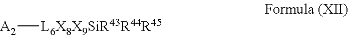

wherein
A₂ is —SH, —NH₂, or —OH;
L₆ is an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, wherein the heteroatom is N, O, or S;
X₈ is —C(═O)—, —C(═O)—O—, —C(═O)—N—, or is absent;
X₉ is an optionally substituted alkylene group having from 1 to 20 carbon atoms and optionally at least one heteroatom, wherein the heteroatom is N, O, or S, or is absent;
R⁴³, R⁴⁴, and R⁴⁵ are each independently —OR⁴⁶, —R⁴⁷, or —OC(═O)R⁴⁸;
R⁴⁶, R⁴⁷, and R⁴⁸ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

In some aspects, the method of making a quinone diimine of Formula (VII) comprises reacting a compound of Formula (V) with an oxidizer. In some aspects, the method of making a quinone diimine of Formula (VII) comprises reacting a compound of Formula (V) with an oxidizer and a catalyst.

In some aspects, the oxidizer is sodium hypochlorite, O₂, or hydrogen peroxide. In some aspects, the oxidizer is hydrogen peroxide.

In some aspects, the catalyst is a platinum catalyst, a palladium catalyst, or a metal oxide. In some aspects, the catalyst is Pt/C, Pd/C, manganese dioxide, copper oxide, iron oxide, nickel oxide, chromium oxide, cobalt oxide, or vanadium oxide. In some aspects, the catalyst is Pt/C.

In some aspects, the catalyst is Pt/C.

In some aspects, the present disclosure provides a method of making a silane compound, wherein the silane compound is the quinone diimine of Formula (VI):

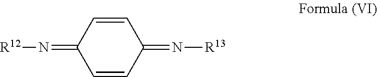

wherein R¹² and R¹³ are as described above;
the method comprising reacting a compound of Formula (IV):

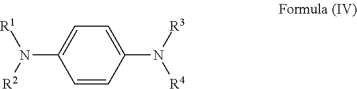

with an oxidizer agent and optionally with a catalyst;
wherein R¹, R², R³, and R⁴ are as described above.

In some aspects, the method of making a quinone diimine of Formula (VI) comprises reacting a compound of Formula (IV) with an oxidizer. In some aspects, the method of making a quinone diimine of Formula (VI) comprises reacting a compound of Formula (IV) with an oxidizer and a catalyst.

In some aspects, the oxidizer is sodium hypochlorite, O₂, or hydrogen peroxide. In some aspects, the oxidizer is hydrogen peroxide.

In some aspects, the catalyst is a platinum catalyst, a palladium catalyst, or a metal oxide. In some aspects, the catalyst is Pt/C, Pd/C, manganese dioxide, copper oxide, iron oxide, nickel oxide, chromium oxide, cobalt oxide, or vanadium oxide. In some aspects, the catalyst is Pt/C.

In some aspects, the present disclosure provides a method of making a silane compound, wherein the silane compound is the quinone diimine of Formula (VII):

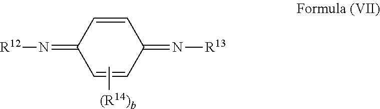

wherein R¹², R¹³, R¹⁴, and b are as described above;
the method comprising reacting a compound of Formula (V):

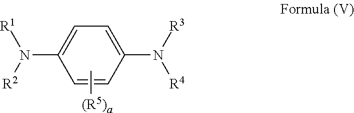

with an oxidizer and optionally with a catalyst;
wherein R¹, R², R³, R⁴, R⁵, and a are as described above.

In some aspects, the method of making a quinone diimine of Formula (VII) comprises reacting a compound of Formula (V) with an oxidizer. In some aspects, the method of making a quinone diimine of Formula (VII) comprises reacting a compound of Formula (V) with an oxidizer and a catalyst.

In some aspects, the oxidizer is sodium hypochlorite, O₂, or hydrogen peroxide. In some aspects, the oxidizer is hydrogen peroxide.

In some aspects, the catalyst is a platinum catalyst, a palladium catalyst, or a metal oxide. In some aspects, the catalyst is Pt/C, Pd/C, manganese dioxide, copper oxide, iron oxide, nickel oxide, chromium oxide, cobalt oxide, or vanadium oxide. In some aspects, the catalyst is Pt/C.

In some aspects, the catalyst is Pt/C.

### V. Method of Making a Silicone Polymer

In some aspects, the present disclosure provides a method of making a silicone polymer, wherein the silicone polymer is represented by Formula (IX):

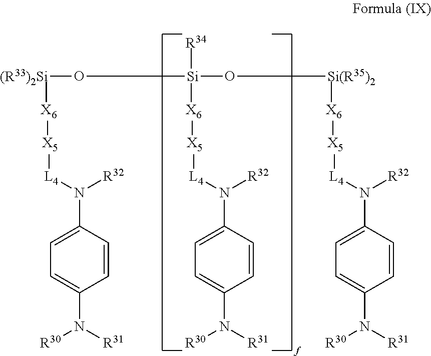

wherein
R³⁰, R³¹, and R³² are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each L₄ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₅ is —C(═O)—, —C(═O)—O—, —C(═O)—N—, or is absent;
X₆ is an optionally substituted alkylene group having from 1 to 20 carbon atoms and optionally at least one heteroatom, wherein the heteroatom is N, O, or S, or is absent;
R³³, R³⁴, and R³⁵ are each independently —OR³⁶, —R³⁷, or —OC(═O)R³⁸; and
R³⁶, R³⁷, and R³⁸ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
f is an integer from 1 to 60;
the method comprising reacting a polymer with a siloxane backbone, wherein the polymer with a siloxane backbone is represented by Formula (XIII):

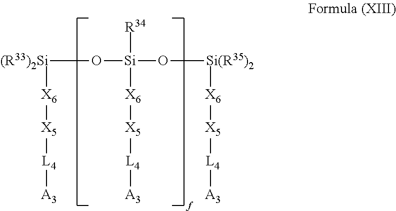

wherein
X₅ is —C(═O)—, —C(═O)—O—, —C(═O)—N—, or is absent;
X₆ is an optionally substituted alkylene group having from 1 to 20 carbon atoms and optionally at least one heteroatom, wherein the heteroatom is N, O, or S, or is absent;
each L₄ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
each A₃ is —Cl, —Br, —OH, a glycidoxy group, a metacryloxypropyl group, or a isocyanatopropyl group;
R³³, R³⁴, and R³⁵ are each independently —OR³⁶, —R³⁷, or —OC(═O)R³⁸; and
R³⁶, R³⁷, and R³⁸ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
f is an integer from 1 to 60;
with a silane compound of Formula (XIV):

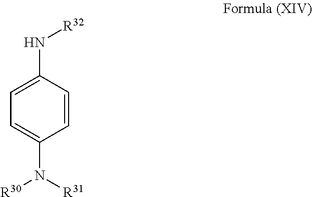

wherein
R³⁰, R³¹, and R³² are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

In some aspects, the silane compound of Formula (XIV) is N-phenyl-p-phenylenediamine.

In some aspects, A₃ is —Cl. In some aspects, A₃ is —Br. In some aspects, A₃ is —OH. In some aspects, A₃ is a glycidoxy group. In some aspects, A₃ is a metacryloxypropyl group. In some aspects, A₃ is an isocyanatopropyl group.

In some aspects, the polymer with a polysiloxane backbone of Formula XIII is COATOSIL™ MP 200 Silane (Momentive Performance Materials Inc., Niskayuna, NY) which can be represented by the following structure:

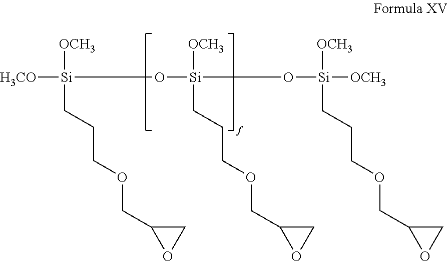

wherein f is an integer from 1 to 4.

### VI. Rubber Compositions

The disclosure relates to a composition comprising one or more silane compounds or silicone polymers described above. The disclosure further relates to a composition comprising one or more silane compounds or silicone polymers prepared by the methods described above.

The disclosure provides a rubber composition comprising the composition described above.

The disclosure provides a rubber composition comprising:
(i) a silane compound described herein or a silicone polymer described herein;
(ii) at least one diene-based polymer; and
(iii) a vulcanizing package comprising at least one vulcanizing agent comprising sulfur and at least one accelerator.

In some aspects, the rubber composition further comprises silica and a silicone coupling agent.

In some aspects, the rubber composition further comprises a filler.

In some aspects, the rubber composition further comprises at least one non-reinforcing filler.

In some aspects, the rubber composition further comprises at least one process aid and at least one plasticizer.

In some aspects, the at least one diene-based polymer is a diene-based polymer containing at least one functional group, a diene-based polymer containing no functional group, or combinations thereof.

In some aspects, the at least one diene-based polymer is natural rubber, a polyisoprene, a polybutadiene, styrene-butadiene copolymer (SBR), or combinations thereof.

In some aspects, the at least one diene-based polymer is butyl rubber, cis 1,4-polyisoprene, cis 1,4-polybutadiene, ethylene propylene diene monomer, a styrene-butadiene copolymer, or combinations thereof.

The disclosure further provides a rubber composition comprising:
(i) about 100 parts of rubber, where the weight of the rubber is the sum of the weights of each diene-based polymer containing at least one functional group used in the formulation and the weights of each diene-based polymer containing no functional group used in the formulation;
(ii) about 1 to about 20 parts by weight per 100 parts rubber in (i) of the composition comprising at least one silane compound or silicone polymer;
(iii) about 5 to about 140 parts by weight per 100 parts rubber in (i) of silica;
(iv) about 0.1 to about 10 parts by weight per 100 parts rubber in (i) of at least one process aid; and
(v) about 0.1 to about 20 parts by weight per 100 parts rubber in (i) of a vulcanizing package comprising at least one vulcanizing agent comprising sulfur and at least one accelerator.

In some aspects, the rubber composition comprises (ii) about 5 to about 140 parts by weight per 100 parts rubber (i) of silica, about 5 to about 100 parts by weight per 100 parts rubber (i) of silica, about 5 to about 60 parts by weight per 100 parts rubber (i) of silica, about 5 to about 20 parts by weight per 100 parts rubber (i) of silica, about 20 to about 140 parts by weight per 100 parts rubber (i) of silica, about 20 to about 100 parts by weight per 100 parts rubber (i) of silica, about 20 to about 60 parts by weight per 100 parts rubber (i) of silica, about 60 to about 140 parts by weight per 100 parts rubber (i) of silica, about 60 to about 100 parts by weight per 100 parts rubber (i) of silica, or about 100 to about 140 parts by weight per 100 parts rubber (i) of silica.

In some aspects, the rubber composition comprises (iii) about 0.1 to about 20 parts by weight per 100 parts rubber (i) of diene-based polymer containing at least one functional group, about 0.1 to about 10 parts by weight per 100 parts rubber (i) of diene-based polymer containing at least one functional group, about 0.1 to about 5 parts by weight per 100 parts rubber (i) of diene-based polymer containing at least one functional group, about 0.1 to about 1 part by weight per 100 parts rubber (i) of diene-based polymer containing at least one functional group, about 1 to about 20 parts by weight per 100 parts rubber (i) of diene-based polymer containing at least one functional group, about 1 to about 10 parts by weight per 100 parts rubber (i) of diene-based polymer containing at least one functional group, about 1 to about 5 parts by weight per 100 parts rubber (i) of diene-based polymer containing at least one functional group, about 5 to about 20 parts by weight per 100 parts rubber (i) of diene-based polymer containing at least one functional group, about 5 to about 10 parts by weight per 100 parts rubber (i) of diene-based polymer containing at least one functional group, or about 10 to about 20 parts by weight per 100 parts rubber (i) of diene-based polymer containing at least one functional group.

In some aspects, the rubber composition comprises (iii) about 0.1 to about 20 parts by weight per 100 parts rubber (i) of at least one silane compound or silicone polymer, about 0.1 to about 10 parts by weight per 100 parts rubber (i) of at least one silane compound or silicone polymer, about 0.1 to about 5 parts by weight per 100 parts rubber (i) of at least one silane compound or silicone polymer, about 0.1 to about 1 part by weight per 100 parts rubber (i) of at least one silane compound or silicone polymer, about 1 to about 20 parts by weight per 100 parts rubber (i) of at least one silane compound or silicone polymer, about 1 to about 10 parts by weight per 100 parts rubber (i) of at least one silane compound or silicone polymer, about 1 to about 5 parts by weight per 100 parts rubber (i) of at least one silane compound or silicone polymer, about 5 to about 20 parts by weight per 100 parts rubber (i) of at least one silane compound or silicone polymer, about 5 to about 10 parts by weight per 100 parts rubber (i) of at least one silane compound or silicone polymer, or about 10 to about 20 parts by weight per 100 parts rubber (i) of at least one silane compound or silicone polymer.

In some aspects, the rubber composition comprises (iv) about 0.1 to about 10 parts by weight per 100 parts rubber (i) of at least one process aid, about 0.1 to about 5 parts by weight per 100 parts rubber (i) of at least one process aid, about 0.1 to about 2.5 parts by weight per 100 parts rubber (i) of at least one process aid, about 0.1 to about 1 part by weight per 100 parts rubber (i) of at least one process aid, about 1 to about 10 parts by weight per 100 parts rubber (i) of at least one process aid, about 1 to about 5 parts by weight per 100 parts rubber (i) of at least one process aid, about 1 to about 2.5 parts by weight per 100 parts rubber (i) of at least one process aid, about 2.5 to about 10 parts by weight per 100 parts rubber (i) of at least one process aid, about 2.5 to about 5 parts by weight per 100 parts rubber (i) of at least one process aid, or about 5 to about 10 parts by weight per 100 parts rubber (i) of at least one process aid.

In some aspects, the rubber composition comprises (v) about 0.1 to about 20 parts by weight per 100 parts rubber (i) of a vulcanization package comprising at least one vulcanizing agent comprising sulfur and at least one accelerator, about 0.1 to about 10 parts by weight per 100 parts rubber (i) of a vulcanization package comprising at least one vulcanizing agent comprising sulfur and at least one accelerator, about 0.1 to about 5 parts by weight per 100 parts rubber (i) of a vulcanization package comprising at least one vulcanizing agent comprising sulfur and at least one accelerator, about 0.1 to about 1 part by weight per 100 parts rubber (i) of a vulcanization package comprising at least one vulcanizing agent comprising sulfur and at least one accelerator, about 1 to about 20 parts by weight per 100 parts rubber (i) of a vulcanization package comprising at least one vulcanizing agent comprising sulfur and at least one accelerator, about 1 to about 10 parts by weight per 100 parts rubber (i) of a vulcanization package comprising at least one vulcanizing agent comprising sulfur and at least one accelerator, about 1 to about 5 parts by weight per 100 parts rubber (i) of a vulcanization package comprising at least one vulcanizing agent comprising sulfur and at least one accelerator, about 5 to about 20 parts by weight per 100 parts rubber (i) of a vulcanization package comprising at least one vulcanizing agent comprising sulfur and at least one accelerator, about 5 to about 10 parts by weight per 100 parts rubber (i) of a vulcanization package comprising at least one vulcanizing agent comprising sulfur and at least one accelerator, or about 10 to about 20 parts by weight per 100 parts rubber (i) of a vulcanization package comprising at least one vulcanizing agent comprising sulfur and at least one accelerator.

The abbreviation “phr” refers to the units for the parts by weight per 100 parts rubber.

In some aspects, the diene-based polymer is a diene-based polymer containing at least one functional group, a diene-based polymer containing no functional group, or combinations thereof.

In some aspects, the diene-based polymer is natural rubber, styrene-butadiene rubber, cis 1,4-polyisoprene, cis 1,4-polybutadiene, trans 1,4-polybutadiene, 1,2-polybutadiene, or combinations thereof.

In some aspects, the process aid is 2,2,4-trimethyl-1,2-dihydroquinoline, N-(1,3-dimethylbutyl)-N′-phenyl-p-phenylenediamine, octyl triethoxysilane, a triethoxysilylated hydrocarbon, zinc stearate, steric acid, zinc soaps of fatty acids, paraffin wax, microcrystalline wax, paraffinic process oil, naphthenic process oil, aromatic process oil, or combinations thereof.

In some aspects, the sulfur in the vulcanizing agent is selected from the group consisting of elemental sulfur, sulfur-donating compounds, and combinations thereof.

In some aspects, the accelerator is selected from the group consisting of benzothiazoles, guanidine derivatives, thiocarbamates, and combinations thereof.

In some aspects, the accelerator is selected from the group consisting of mercapto benzothiazole, benzothiazole disulfide, diphenylguanidine, zinc dithiocarbamate, alkylphenoldisulfide, zinc butyl xanthate, N-dicyclohexyl-2-benzothiazolesulfenamide, N-cyclohexyl-2-benzothiazolesulfenamide, N-oxydiethylenebenzothiazole-2-sulfenamide, N,N-diphenylthiourea, dithiocarbamylsulfenamide, N,N-diisopropylbenzothiozole-2-sulfenamide, zinc-2-mercaptotoluimidazole, dithiobis(N-methyl piperazine), dithiobis(N-beta-hydroxy ethyl piperazine), dithiobis(dibenzyl amine), and combinations thereof.

In some aspects, the rubber composition further comprises at least one filler from about 0.1 to about 20 parts by weight per 100 parts rubber. In some aspects, the rubber composition comprises about 0.1 to about 20 parts by weight per 100 parts rubber of at least one filler, about 0.1 to about 10 parts by weight per 100 parts rubber of at least one filler, about 0.1 to about 5 parts by weight per 100 parts rubber of at least one filler, about 0.1 to about 1 part by weight per 100 parts rubber of at least one filler, about 1 to about 20 parts by weight per 100 parts rubber of at least one filler, about 1 to about 10 parts by weight per 100 parts rubber of at least one filler, about 1 to about 5 parts by weight per 100 parts rubber of at least one filler, about 5 to about 20 parts by weight per 100 parts rubber of at least one filler, about 5 to about 10 parts by weight per 100 parts rubber of at least one filler, or about 10 to about 20 parts by weight per 100 parts rubber of at least one filler.

In some aspects, the filler is selected from the group consisting of titanium dioxide, alumina, aluminosilicates, siliceous materials, carbon black, acetylene black, calcium carbonate, barium sulfate, and combinations thereof. In some aspects, the filler is carbon black.

In some aspects, the rubber composition further comprises at least one process oil from about 0.1 to about 20 parts by weight per 100 parts rubber. In some aspects, the process oil is treated distillate aromatic extracted (TDAE) oil. In some aspects, the rubber composition comprises about 0.1 to about 20 parts by weight per 100 parts rubber of at least one process oil, about 0.1 to about 10 parts by weight per 100 parts rubber of at least one process oil, about 0.1 to about 5 parts by weight per 100 parts rubber of at least one process oil, about 0.1 to about 1 part by weight per 100 parts rubber of at least one process oil, about 1 to about 20 parts by weight per 100 parts rubber of at least one process oil, about 1 to about 10 parts by weight per 100 parts rubber of at least one process oil, about 1 to about 5 parts by weight per 100 parts rubber of at least one process oil, about 5 to about 20 parts by weight per 100 parts rubber of at least one process oil, about 5 to about 10 parts by weight per 100 parts rubber of at least one process oil, or about 10 to about 20 parts by weight per 100 parts rubber of at least one process oil.

In some aspects, the rubber composition further comprises at least one activator from about 0.1 to about 20 parts by weight per 100 parts rubber. In some aspects, the activator is zinc oxide or stearic acid. In some aspects, the rubber composition comprises about 0.1 to about 20 parts by weight per 100 parts rubber of at least one activator, about 0.1 to about 10 parts by weight per 100 parts rubber of at least one activator, about 0.1 to about 5 parts by weight per 100 parts rubber of at least one activator, about 0.1 to about 1 part by weight per 100 parts rubber of at least one activator, about 1 to about 20 parts by weight per 100 parts rubber of at least one activator, about 1 to about 10 parts by weight per 100 parts rubber of at least one activator, about 1 to about 5 parts by weight per 100 parts rubber of at least one activator, about 5 to about 20 parts by weight per 100 parts rubber of at least one activator, about 5 to about 10 parts by weight per 100 parts rubber of at least one activator, or about 10 to about 20 parts by weight per 100 parts rubber of at least one activator.

In some aspects, the rubber composition further comprises at least one antidegradant from about 0.1 to about 20 parts by weight per 100 parts rubber. In some aspects, the antidegradant is a silane compound or a silicone polymer described herein. In some aspects, the rubber composition comprises about 0.1 to about 20 parts by weight per 100 parts rubber of at least one antidegradant, about 0.1 to about 10 parts by weight per 100 parts rubber of at least one antidegradant, about 0.1 to about 5 parts by weight per 100 parts rubber of at least one antidegradant, about 0.1 to about 1 part by weight per 100 parts rubber of at least one antidegradant, about 1 to about 20 parts by weight per 100 parts rubber of at least one antidegradant, about 1 to about 10 parts by weight per 100 parts rubber of at least one antidegradant, about 1 to about 5 parts by weight per 100 parts rubber of at least one antidegradant, about 5 to about 20 parts by weight per 100 parts rubber of at least one antidegradant, about 5 to about 10 parts by weight per 100 parts rubber of at least one antidegradant, or about 10 to about 20 parts by weight per 100 parts rubber of at least one antidegradant.

In some aspects, the rubber composition further comprises at least one second antidegradant from about 0.1 to about 10 parts by weight per 100 parts rubber. In some aspects, the second antidegradant can be a non-silane antidegradant. In some aspects, the at least one non-silane antidegradant can be 2,2,4-trimethyl-1,2-dihydroquinoline polymer or a microcrystalline wax. In some aspects, the rubber composition comprises about 0.1 to about 10 parts by weight per 100 parts rubber of at least one non-silane antidegradant, about 0.1 to about 5 parts by weight per 100 parts rubber of at least one non-silane antidegradant, about 0.1 to about 1 part by weight per 100 parts rubber of at least one non-silane antidegradant, about 1 to about 10 parts by weight per 100 parts rubber of at least one non-silane antidegradant, about 1 to about 5 parts by weight per 100 parts rubber of at least one non-silane antidegradant, or about 5 to about 10 parts by weight per 100 parts rubber of at least one non-silane antidegradant. In some aspects, the rubber composition further comprises one non-silane antidegradant. In some aspects, the rubber composition further comprises two non-silane antidegradants.

The measured properties of the rubber composition and their testing instruments and methods are shown in Table 1.

TABLE 1

| Performance Indicator | Measurement | Equipment | Method |
|---|---|---|---|
| Processing Indicator | Mooney Viscosity, ML(1 + 4) | Monsanto MV2000 | ASTM D-1646 |
| | 100° C. | | |
| Processing Indication | Mooney Scorch, 3 point rise or | Monsanto MV2000 | ASTM D-1646 |
| | 10 points | | |
| Processing Indicator | MDR MIN/MAX Torque T10, | MDR2000 | ASTM F5289-12 |
| | 40, 90, 95 | | |
| | Specific Gravity | Wallace Electronic | ASTM-D-297 |
| | | Densimeter | |
| Wear Indicator | Tensile Strength | CubeOne Tensilemeter | ASTM D-412 |
| Wear Indicator | % Elongation | CubeOne Tensilemeter | ASTM D-412 |
| Wear Indicator | Modulus, M50, 100, 200, 300, | CubeOne Tensilemeter | ASTM D-412 |
| | Break Energy, Graves Tear @ | | |
| | 25° C. | | |
| Handling Indicator | Shore A Hardness | Zwick Shore Hardness | ASTM D-2240 |
| | | Tester | |
| Wear Indicator | DIN Abrasion (mass loss) | DIN Rotary Abrader | ASTM D-5963 |
| Grip Indicator Rolling | Rebound at 0° C. | Zwick 5109 Rebound | ASTM D-7121 |
| Resistance | Rebound at 70° C. | Resilience Tester | |
| Rolling Resistance | RPA G′ @ 2%, 5%, 10% | TA RPA Elite | ASTM D-6601 |
| Indicator | RPA Tan δ @ 2%, 5%, 10% | | |

In some aspects, the rubber composition has a Mooney viscosity of from about 40 MU to about 150 MU as measured using the ASTM D-1646 method. In a further aspect, the rubber composition has a Mooney viscosity of from about 120 MU to about 140 MU. In another aspect, the rubber composition has a Mooney viscosity of from about 40 MU to about 100 MU. In some aspects, the rubber composition has a Mooney viscosity of about 40, about 45, about 50, about 55, about 60, about 65, about 70, about 75, about 80, about 85, about 90, about 95, about 100, about 105, about 110, about 115, about 120, about 125, about 130, about 135, about 140, about 145, or about 150 MU.

In some aspects, the rubber composition has a tensile strength of from about 5 MPa to about 25 MPa as measured by the ASTM D-412 method. In a further aspect, the rubber composition has a tensile strength of from about 15 MPA to about 20 MPa. In another aspect, the rubber composition has a tensile strength of from about 10 MPa to about 15 MPa. In some aspects, the rubber composition has a tensile strength of about 5, about 10, about 15, about 20, or about 25 MPa.

The disclosure further provides to an article of manufacture comprising the rubber composition described above. In some aspects, the article of manufacture includes but is not limited to a tire, a conveyor belt, an engine mount, a shoe sole, a tubing, a glove, a windshield wiper, a brake pad, an eraser, a rubber band, a grip, a brayer, a flame retardant, and a polishing pad.

In some aspects, the rubber composition is used in the manufacture of a tire tread, a tire undertread, a tire carcass, a tire sidewall, or a tire bead.

### EXAMPLES

The following examples are included to demonstrate various aspects of the present disclosure. It should be appreciated by those of skill in the art that the techniques disclosed in the examples that follow represent techniques discovered by the inventors to function well in the practice of the disclosure, and thus can be considered to constitute preferred modes for its practice. However, those of skill in the art should, in light of the present disclosure, appreciate that many changes can be made in the specific examples which are disclosed and still obtain a like or similar result without departing from the spirit and scope of the disclosure.

### Example 1: Synthesis of N⁴-(4-methylpentan-2-yl)-N¹-phenyl-((3-(triethoxysilyl)propyl) thio)benzene-1,4-diamine

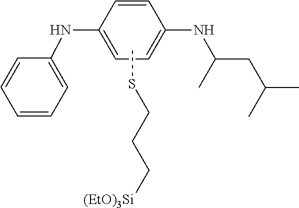

To a 3-liter four-neck round-bottom flask was added 301.1 grams of N-(1,3-dimethylbuytyl)-N′-phenyl-1,4-benzenediamine (6PPD). After charging the flask, cyclohexane solvent was added to dissolve the 6PPD. The mixture was mechanically stirred and heated to 40° C. 8.0 grams of Pt/C (5%) catalyst was added to the flask, followed by the slow addition of 15% hydrogen peroxide. The reaction temperature was maintained between 37-45° C. The reaction was monitored by gas chromatography until 95% of the conversion of 6PPD was completed. The reaction mixture was then filtered to remove the catalyst. The filtrate was phase separated. The organic layer was stripped off to remove cyclohexane and a viscous liquid was generated. Ethanol was then added to this liquid and followed with the addition of (3-mercaptopropyl)triethoxysilane (231.0 grams). After the reaction was done, ethanol was stripped off to yield 476 grams of the product.

### Example 2: Synthesis of Quinone Diimine Silane

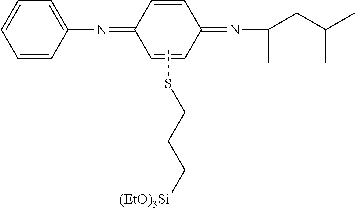

199.1 g of the silane compound prepared in Example 1 was added to a reaction flask. The flask was heated to 40° C., followed by the slow addition of 2.0 grams of Pt/C catalyst (5%). 15% H2O2 solution was then slowly added to the reaction. The reaction temperature was maintained around 40° C. by using a water bath. The reaction progress was monitored by 1H NMR until 90% conversion of the silane compound of Example 1 to a quinone diimine silane (QDI-silane) was complete. The reaction mixture was filtered then phase separated. The organic layer was washed with 9% NaHCO₃ solution twice and dried under vacuum to generate 175.0 grams of a QDI-silane product.

### Example 3: Synthesis of N¹-phenyl-N⁴-(3-(triethoxysilyl)propyl)benzene-1,4-diamine

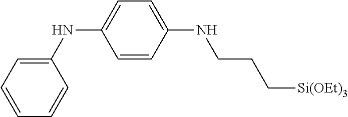

To a five-neck 1 L round-bottomed flask equipped with a thermocouple was added 124.7 grams (0.68 moles) of N-phenyl-p-phenylenediamine using a addition funnel. 165.0 grams (0.68 moles) of chloropropyltriethoxysilane and solvent-grade xylene were added with mechanical stirring to the reaction flask and the reaction temperature was increased to 160° C. Sodium ethoxide (107 grams (21% in ethanol)) was slowly added to the reaction flask through an additional funnel during the course of the reaction. The reaction was monitored by gas chromatography until the chloropropyltriethoxysilane was less than 3% of the reaction mixture. At the end of the reaction, the mixture was cooled to room temperature and washed with 5% brine solution. After phase separation, the top layer was separated and filtered to provide a filtrate. The top layer was washed with an ethylenediamine dihydrochloride/ethylenediamine solution and then dried under vacuum to provide 194.0 grams of a dark colored material.

### Example 4: Synthesis of 1-((4-phenylamino)phenyl)amino)-3-(3-(trimethylsilyl) propoxy)propan-2-ol

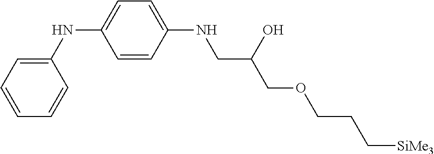 [SMILES: C[Si](C)(C)CCCOCC(O)CNc1ccc(Nc2ccccc2)cc1]

N-phenyl-p-phenylenediamine (184 grams (1 mole)) and (3-glycidyloxypropyl)triethoxysilane (278 grams (1 mole)) can be added to a reaction flask under a nitrogen atmosphere. The reaction mixture can be heated to between 50-140° C. for about 10 hours. The product can be collected at the end of the reaction.

### Example 5: Synthesis of 3-(trimethoxysilyl)propyl 2-methyl-3-((4-(phenylamino) phenyl)amino)propanoate

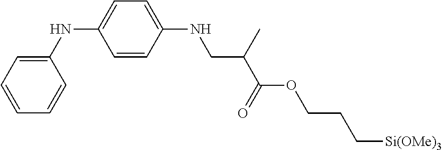

N-phenyl-p-phenylenediamine (184 grams (1 mole)) and 3-methacryloxypropyltrimethoxysilane (248 grams (1 mole)) can be added to a reaction flask under a nitrogen atmosphere. The reaction mixture can be heated to between 20-80° C. in the presence of either an acid or a base. The product can be collected at the end of the reaction.

### Example 6: Synthesis of 1-(4-(phenylamino)phenyl)-3-(3-(triethoxysilyl)propyl)urea

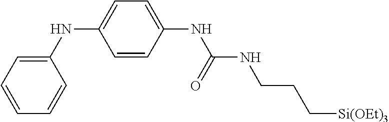

N-phenyl-p-phenylenediamine (184 grams (1 mole)) and 3-methacryloxypropyl trimethoxysilane (248 grams (1 mole)) can be added to a reaction flask under a nitrogen atmosphere. The reaction mixture can be heated to between 20-80° C. in the presence of either an acid or a base. The product can be collected at the end of the reaction.

### Example 7: Synthesis of N¹-phenyl-N⁴-(4-(triethoxysilyl)butyl)cyclohexa-2,5-diene-1,4-diimine

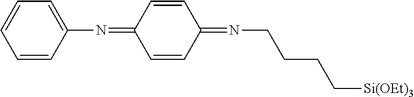

N-phenyl-N′-(3-triethoxysilylpropyl)-benzene-1,4-diamine (388 grams) can be dissolved in cyclohexane solvent. The mixture can be heated to 40° C. 5% Pt/C (1.0 grams) catalyst can be added to the mixture followed by the slow addition of 12% hydrogen peroxide solution. The mixture can be maintained at about 40° C. At the end of the reaction, the catalyst can be filtered out and the filtrate can be stripped to remove the solvent. The product can be collected at the end of the reaction.

### Example 8: Synthesis of Silicone Polymer

Under a nitrogen atmosphere, 150.0 grams of COATOSIL™ MP200 silane (Momentive Performance Materials Inc., Niskayuna, NY) and 124.7 grams of N-phenyl-p-phenylenediamine are added to a flask containing 150 grams of xylenes solvent. The reaction mixture is heated to a temperature between 50° C. and 140° C. for about 10 hours. The solvent is stripped under vacuum at the end of the reaction. The product can be collected at the end of the reaction.

### Example 9: Preparation of Rubber Compositions

### 9.1 Preparation of Rubber Compositions

Rubber composition in this example were prepared by mixing the ingredients as follows in a BANBURY®¹ mixer with a 103-cu. in. (1690 cc) chamber volume. The mixing of the rubber was performed in three steps. The mixing of the rubber was performed in three steps. ¹Model BR-1600, ASTM 3182 certified laboratory mixer, Farrell Corp.

### 9.1.1. First Mixing Step: Non-Productive 1 (NP1)

The mixer was set at a rotor speed of 75 rpm and a temperature of 145° F.+/−5° F. (63° C.) and maintained at this temperature throughout the first two steps of mixing. In the first mixing step, referred to as Non-productive 1 (NP1), the rubber formulation was set at a mixing chamber fill factor of 73%. The polymers were added to the mixer and ram down mixed for 40 seconds. Then half of the silica and NXT Silane and/or the silane compound of Example 1 are added to the mixer and ram down mixed for 90 seconds. Next the rest of the silica and the other ingredients of NP1, except for the carbon black and process oil, are added and mixed to a temperature of 260° F. (127° C.). 6PPD may or may not be added in this step. Then the carbon black and process oil are added to the mixer and mixed to a temperature of 275° F. (135° C.). The mixer was swept to ensure all the materials were added to the mixing chamber. The ingredients were mixed to a temperature of 311° F. (155° C.) at a speed of less than 95 rpm and held at constant temperature for 90 seconds. The total mixing time of NP1 was approximately 330 seconds. The material was discharged from the mixing chamber and milled on a two-roll mill (two-cylinder roll mills, Farrell Corp.) set at a temperature of approximately 140° F. (60° C.). The rubber was allowed to wrap around one cylinder and form a rolling bank of rubber at the nip between the two cylinders. A crosscut of the rubber during milling while wrapped, starting with a 1-inch ribbon, from left to right with 1 inch per revolution was made as the rubber was removed from the mill. These milling steps were repeated five times and then rubber was removed from the two-roll mill and allowed to cool to ambient temperature. The NP1 rubber was set aside for the next mixing step.

### 9.1.2. Second Mixing Step: Non-Productive 2 (NP2)

In the second mixing step, referred to as Non-productive 2 (NP2), the NP1 rubber was cut down for 70% fill factor. The cutdown NP1 rubber was added to the mixer and ram down mixed until the temperature reached 275° F. and then continued to mix at constant temperature for 90 seconds. The mixer was swept to ensure all the materials were added to the mixing chamber. The rubber was then mixed to a temperature of 311° F. (155° C.) at a speed of less than 95 rpm and held at constant temperature for 90 seconds. The total mixing time of NP2 was approximately 200 seconds. The material was discharged from the mixing chamber and milled on a two-roll mill (two-cylinder roll mills, Farrell Corp.) set at a temperature of approximately 140° F. (60° C.). The rubber was allowed to wrap around one cylinder and form a rolling bank of rubber at the nip between the two cylinders. A crosscut of the rubber during milling while wrapped, starting with a 1-inch ribbon, from left to right with 1 inch per revolution was made as the rubber was removed from the mill. These milling steps were repeated five times and then rubber was removed from the two-roll mill and allowed to cool to ambient temperature. The NP2 rubber was set aside for the final mixing step.

### 9.1.3. Final Mixing Step: Productive Step (FM)

In the final mixing step, referred to as the Productive step, or Final Mix (FM), the mixer temperature was set to 100° F. (38° C.). The NP2 rubber was cut down to allow for a fill factor of 68%, including vulcanization chemicals to be added. The NP2 rubber and vulcanization chemicals were charged into the mixer and mixed at 50 rpm to a temperature of 200° F. (93° C.) and held at constant temperature for a total mixing time of 170 seconds. The rubber was further mixed at a rotor speed of 75 rpm to a temperature of 212° F. (100° C.). The total mixing time of the FM was 215 seconds. After mixing, the FM rubber was discharged from the mixing chamber and milled on a two-roll mill set at a temperature of 140° F. (60° C.) to form a sheet and then allowed to cool to ambient temperature. Part of the sheet was used to measure the uncured properties, such as Mooney viscosity. Part of the sheet was cured in stainless steel molds. The curing conditions were 320° F. (160° C.) for 15 minutes at the pressure rated for the specific curing press and mold. The cured samples were used to measure the cured properties of the rubber compositions. Part of the cured samples were set aside to be tested in advanced rubber aging conditions such as in an ozone chamber or in an oven.

### 9.2 Components of Prepared Rubber Compositions

Table 2 presents the ingredients used to prepare rubber compositions. The rubber compositions were mixed using a BANBURY® mixer with two non-productive stages and one productive stage. Comparative Example 9A was done in the presence of Zeosil 1165MP and NXT* coupling agent as well as 6PPD. Comparative Example 9C was done in the presence of Zeosil 1165MP and NXT* coupling agent but in the absence of 6PPD. Comparative Example 9E was done in the absence of Zeosil 1165MP and NXT* coupling agent but in the presence of 6PPD. Comparative Example 9G was done in the absence of Zeosil 1165MP and NXT* coupling agent as well as 6PPD. Each of Examples 9B, 9D, 9F, and 9H was paired with a control where the silane compound of Example 1 was added. All of the 8 compositions included either: (1) the combination of Zeosil 1165MP and NXT* coupling agent; or (2) N330 CB (carbon black). Carbon black compositions served as negative controls (Comparative Examples 9E and 9G and their control with the silane compound of Example 1 (Examples 9F and 9H, respectively). The silane compound of Example 1 was introduced into the rubber composition at a concentration of 3.8 phr (parts per hundred rubber). This concentration was determined by calculating and maintaining an equal stoichiometric amount of antiozonant moiety of 6PPD utilizing the molecular weights of 6PPD (268.4 g/mol) and the silane compound of Example 1 (504.8 g/mol). The ingredients of 8 compositions and their total weights at each mixing steps are summarized in Table 2.

TABLE 2
Components of Prepared Rubber Compositions

| | Comparative | Example | Comparative | Example | Comparative | Example | Comparative | Example |
|---|---|---|---|---|---|---|---|---|
| Ingredients | Example 9A | 9B | Example 9C | 9D | Example 9E | 9F | Example 9G | 9H |
| BUNA V SL | 103.1 | 103.1 | 103.1 | 103.1 | 103.1 | 103.1 | 103.1 | 103.1 |
| 4526-2 HM¹ | | | | | | | | |
| BUNA CB 24² | 25 | 25 | 25 | 25 | 25 | 25 | 25 | 25 |
| Zeosil 1165MP³ | 80 | 80 | 80 | 80 | | | | |
| N330 CB⁴ | 10 | 10 | 10 | 10 | 82 | 82 | 82 | 82 |
| TDAE⁵ | 5 | 5 | 5 | 5 | 5 | 5 | 5 | 5 |
| 6PPD⁶ | 2 | 2 | | | 2 | 2 | | |
| MC Wax⁷ | 1.5 | 1.5 | 1.5 | 1.5 | 1.5 | 1.5 | 1.5 | 1.5 |
| ZnO⁸ | 1 | 1 | 1 | 1 | 1 | 1 | 1 | 1 |
| Stearic Acid⁹ | 2 | 2 | 2 | 2 | 2 | 2 | 2 | 2 |
| NXT* Silane¹⁰ | 6.4 | 6.4 | 6.4 | 6.4 | | | | |
| Example 1 Silane¹¹ | | 3.8 | | 3.8 | | 3.8 | | 3.8 |
| NP1 Total | 236.0 | 239.8 | 234.0 | 237.8 | 221.6 | 225.4 | 219.6 | 223.4 |
| NP2 Total | 236.0 | 239.8 | 234.0 | 237.8 | 221.6 | 225.4 | 219.6 | 223.4 |
| ZnO | 1.5 | 1.5 | 1.5 | 1.5 | 1.5 | 1.5 | 1.5 | 1.5 |
| Sulfur¹² | 2.1 | 2.1 | 2.1 | 2.1 | 2.1 | 2.1 | 2.1 | 2.1 |
| CBS¹³ | 2.1 | 2.1 | 2.1 | 2.1 | 2.1 | 2.1 | 2.1 | 2.1 |
| DPG¹⁴ | 1.5 | 1.5 | 1.5 | 1.5 | 1.5 | 1.5 | 1.5 | 1.5 |
| FM Total | 243.2 | 247.0 | 241.2 | 245.0 | 228.8 | 232.6 | 226.8 | 230.6 |

¹Buna ® VSL 4526-2 HM from ARLANXEO is a standard S-SBR (styrene butadiene rubber);
²Buna ® CB 24 from ARLANXEO is a neodymium BR (butadiene rubber);
³ZEOSIL ® 1165MP from Solvay is a synthetic amorphous precipitated highly dispersible silica (HDS) micropearl with BET surface area of 165 m²/g;
⁴N330 carbon black from Tokai Carbon is a medium reinforcing filler with BET surface area of 78 m²/g;
⁵The TDAE oil used in this study was Vivatec 500 from H&R Group;
⁶6PPD used in this study was STANGARD ® 6PPD sourced from Harwick Standard is a rubber staining antiozonant and antioxidant;
⁷MC Wax is a microcrystalline wax called CS-2040 petroleum hydrocarbon mixture sourced from HB Chemical used as a rubber antidegradant;
⁸ZnO, or zinc oxide, used in this study was ZNO AZO-66T sourced from HB Chemical as a rubber vulcanization activator;
⁹Stearic acid used in this study was STEARIC ACID R Prill sourced from HB Chemical as a rubber vulcanization activator;
¹⁰NXT ™ Silane is an organofunctional silane coupling agent for silica reinforcement and dispersion in rubber;
¹¹The silane compound as described in Example 1;
¹²Sulfur used in this study was 209 OIL TREATED RM SULFUR sourced from Harwick Standard as a vulcanization chemical;
¹³CBS, or N-cyclohexyl-2-benzothiazole sulfenamide (CAS# 95-33-0), used in this study was KEMAI CBS GR sourced from Harwick Standard was used as a rubber vulcanization accelerator;
¹⁴DPG, or 1,3-Diphenylguanidine (CAS# 102-06-7), used in this study was EKALAND ™ DPG C sourced from Harwick Standard as a rubber vulcanization accelerator.

### Example 10. Properties of the Prepared Rubber Compositions

The test procedures for evaluating the vulcanized (cured) rubber compositions herein are described using the methods described in Table 1. Tables 3, 4, and 5 summarize processing properties, physical properties, and dynamic properties of each of the eight rubber compositions listed in Table 2.

TABLE 3
Processing Properties of Prepared Rubber Compositions

| | | | | | | | | | |
|---|---|---|---|---|---|---|---|---|---|
| Processing | | Comparative | Example | Comparative | Example | Comparative | Example | Comparative | Example |
| Properties | Units | Example 9A | 9B | Example 9C | 9D | Example 9E | 9F | Example 9G | 9H |

Mooney Viscosity

| | | | | | | | | | |
|---|---|---|---|---|---|---|---|---|---|
| MB1 CMS1 + | MU | 136 | 117 | 132 | 109 | 87 | 87 | 87 | 90 |
| 4(100° C.) | | | | | | | | | |
| MB2 CMS1 + | MU | 96 | 88 | 97 | 85 | 77 | 78 | 77 | 82 |
| 4(100° C.) | | | | | | | | | |
| FM CML1 + | MU | 71 | 67 | 72 | 66 | 65 | 66 | 67 | 69 |
| 4(100° C.) | | | | | | | | | |

Mooney Scorch @135° C.

| | | | | | | | | | |
|---|---|---|---|---|---|---|---|---|---|
| Small Rotor | minutes | 19 | 20 | 19 | 22 | 6 | 5 | 6 | 5 |
| 3 pt rise | | | | | | | | | |
| Small Roter | minutes | 23 | 25 | 24 | 27 | 7 | 6 | 8 | 7 |
| 10 pt rise | | | | | | | | | |

MDR @ 160° C., 30 Min

| | | | | | | | | | |
|---|---|---|---|---|---|---|---|---|---|
| MIN Torque | dMm | 3 | 2 | 3 | 2 | 2 | 2 | 2 | 3 |
| MAX Torque | dMm | 22 | 19 | 23 | 18 | 18 | 17 | 19 | 18 |
| Δ Torque | dMm | 19 | 16 | 21 | 16 | 15 | 15 | 16 | 15 |
| T10 | minutes | 3 | 4 | 4 | 4 | 1 | 1 | 1 | 1 |
| T40 | minutes | 5 | 6 | 6 | 6 | 2 | 2 | 2 | 2 |
| T90 | minutes | 15 | 12 | 14 | 13 | 5 | 4 | 4 | 4 |
| T95 | minutes | 20 | 17 | 19 | 17 | 6 | 5 | 5 | 5 |

TABLE 4
Physical Properties of Prepared Rubber Compositions

| Physical | | Comparative | Example | Comparative | Example | Comparative | Example | Comparative | Example |
|---|---|---|---|---|---|---|---|---|---|
| Properties | Units | Example 9A | 9B | Example 9C | 9D | Example 9E | 9F | Example 9G | 9H |
| Specific Gravity | g/cm³ | 1.19 | 1.19 | 1.19 | 1.19 | 1.16 | 1.16 | 1.16 | 1.16 |
| 50% Modulus | MPa | 1.2 | 1.2 | 1.4 | 1.3 | 1.5 | 1.5 | 1.6 | 1.5 |
| 100% Modulus | MPa | 2.3 | 2.2 | 2.6 | 2.4 | 3.3 | 3.1 | 3.6 | 3.3 |
| 200% Modulus | MPa | 5.9 | 5.8 | 6.5 | 6.1 | 9.6 | 9.1 | 10.2 | 9.6 |
| 300% Modulus | MPa | 10.8 | 10.5 | 11.5 | 10.9 | 15.6 | 14.9 | ND | 15.5 |
| RI (M300/M100) | ND | 4.7 | 4.8 | 4.5 | 4.6 | 4.8 | 4.8 | ND | 4.7 |
| Tensile | MPa | 16.0 | 15.8 | 14.4 | 15.2 | 15.1 | 14.4 | 11.7 | 15.1 |
| Elongation | % | 439 | 449 | 386 | 422 | 317 | 318 | 243 | 319 |
| Shore A @ 25° C. | Shore A | 63 | 62 | 67 | 62 | 64 | 63 | 65 | 64 |
| Shore A @ 70° C. | Shore A | 62 | 60 | 64 | 61 | 60 | 60 | 62 | 61 |
| FtF (Fatigue to Failure) | KC | 179 | 613 | 54 | 92 | 130 | 166 | 29 | 113 |
| DIN Abrasion | mm³ | 112 | 119 | 120 | 117 | 112 | 115 | 119 | 117 |

TABLE 5
Dynamic Properties of Prepared Rubber Compositions

| | | | | | | | | | |
|---|---|---|---|---|---|---|---|---|---|
| Dynamic | | Comparative | Example | Comparative | Example | Comparative | Example | Comparative | Example |
| Properties | Units | Example 9A | 9B | Example 9C | 9D | Example 9E | 9F | Example 9G | 9H |

Rebound

| | | | | | | | | | |
|---|---|---|---|---|---|---|---|---|---|
| 0° C. | % | 16 | 17 | 16 | 15 | 17 | 19 | 17 | 18 |
| 25° C. | % | 28 | 30 | 28 | 27 | 28 | 28 | 27 | 28 |
| 70° C. | % | 48 | 50 | 47 | 48 | 48 | 48 | 47 | 47 |
| 100° C. | % | 55 | 57 | 53 | 55 | 56 | 54 | 56 | 55 |

RPA 2000 - Strain Sweep @ 60° C.

| | | | | | | | | | |
|---|---|---|---|---|---|---|---|---|---|
| G′ @ 2% | MPa | 4.6 | 3.5 | 4.6 | 3.2 | 3.9 | 3.8 | 4.3 | 4.0 |
| G′ @ 5% | MPa | 3.2 | 2.6 | 3.3 | 2.3 | 2.6 | 2.5 | 2.8 | 2.7 |
| G′ @ 10% | MPa | 2.3 | 2.0 | 2.4 | 1.9 | 2.0 | 2.0 | 2.2 | 2.1 |
| Tan δ @ 2% | Unitless | 0.123 | 0.111 | 0.121 | 0.140 | 0.181 | 0.174 | 0.189 | 0.176 |
| Tan δ @ 5% | Unitless | 0.136 | 0.129 | 0.135 | 0.142 | 0.210 | 0.204 | 0.220 | 0.205 |
| Tan δ @ 10% | Unitless | 0.137 | 0.116 | 0.141 | 0.131 | 0.179 | 0.177 | 0.189 | 0.178 |

Metravib - Strain Sweep

| | | | | | | | | | |
|---|---|---|---|---|---|---|---|---|---|
| G′ @ 0.1% | Mpa | 4.3 | 3.8 | 5.2 | 3.9 | 4.1 | 3.9 | 4.5 | 4.2 |
| G′ @ 10% | Mpa | 1.8 | 1.7 | 2.1 | 1.7 | 1.5 | 1.4 | 1.6 | 1.6 |
| Δ G′ (Payne Effect) | Mpa | 2.4 | 2.1 | 3.1 | 2.2 | 2.5 | 2.4 | 2.9 | 2.7 |
| Tan δ max | Unitless | 0.168 | 0.174 | 0.172 | 0.182 | 0.238 | 0.246 | 0.252 | 0.245 |

Metravib - Temperature Sweep

| | | | | | | | | | |
|---|---|---|---|---|---|---|---|---|---|
| Tan δ @ 60° C. | Unitless | 0.158 | 0.183 | 0.164 | 0.175 | 0.230 | 0.244 | 0.238 | 0.224 |
| Tan δ @ Tg | Unitless | 0.531 | 0.555 | 0.498 | 0.538 | 0.569 | 0.554 | 0.545 | 0.556 |
| Tan δ @ 0° C. | Unitless | 0.348 | 0.355 | 0.306 | 0.388 | 0.336 | 0.288 | 0.318 | 0.298 |
| Tan δ @ 100° C. | Unitless | 0.121 | 0.128 | 0.127 | 0.125 | 0.158 | 0.173 | 0.172 | 0.163 |

Results can be summarized from the overall properties shown in TABLE 3, TABLE 4, and TABLE 5. Based on the results, the silane compound of Example 1 can be used to replace 6PPD and provide similar properties to the rubber composition. Additionally, the silane compound of Example 1 can also work in combination with 6PPD as an antiozonant in a carbon black recipe without the need of silica, as shown in comparative Example 9B and its counterpart Example 1 (no 6PPD) (Example 9D), as well as Example 9F and its counterpart Example 1 (no 6PPD) (Example 9H). In the antiozone test in Example 10 method A, a recovery of ozone resistance was observed when the silane compound of Example 1 was introduced to the rubber compositions where 6PPD was absent (Example 9D and Example 9H in TABLE 5).

When replacing 6PPD with the silane compound of Example 1 in both silica and carbon black compositions, the physical properties were recovered (comparing Comparative Example 9A to Example 9D and comparing Comparative Example 9E to Example 9H). FtF (Fatigue to Failure) and elongation at break are the most sensitive properties to degradation effects like oxidation. According to TABLE 5, there is a clear improvement in fatigue resistance and elongation at break when the silane compound of Example 1 is added to the compositions which had 6PPD removed. In both silica and carbon black compositions, the fatigue resistance and elongation at break deteriorated when 6PPD was omitted in the rubber mix, shown in Comparative Example 9C and Comparative Example 9G. In the compositions which used the silane compound of Example 1 to replace 6PPD, significant improvement was observed in these two properties, as suggested in Example 9D and Example 9H.

There were limited to no negative impacts from introducing a secondary silane chemical in a silica rubber composition (Examples 9B, 9D, 9F, and 9H). The expectation was there might have been competition between NXT™ Silane and the silane compound of Example 1 for silica surface; however, all modulus, reinforcement, and hysteretic properties indicated no negative effects. Indeed, the decreased Payne effect may benefit rolling resistance properties if rigidity were one of the parameters to be adjusted using common formulation approaches known to one skilled in the art (TABLE 5).

### Example 11. Testing Results of Rubber Compositions

The eight prepared rubber compositions were subjected to antiozone test and leaching experiment. The testing results are summarized in TABLEs 6-8.

### 11.1 Antiozone Test

The ozone resistance was tested by comparing antiozone property of silane containing antidegradant compounds in rubber to that of commercial antidegradant, such as 6PPD and unprotected rubber. The tests were conducted with two methods: ASTM D1149 Method A and ASTM D1149 Method B, with the results summarized in TABLE 6 and TABLE 7, individually.

TABLE 6
Ozone Resistance, ASTM D 1149 Method A, Procedure A1^{a}

| Filler | Comparative | Example | Comparative | Example |
|---|---|---|---|---|
| Material | Example 9A | 9B | Example 9C | 9D |
| Silica | Small | Very | Large | Medium |
| Filler | Crack | Small | Crack | Crack |
| | | Crack | | |
| Filler | Comparative | Example | Comparative | Example |
| Material | Example 9E | 9F | Example 9G | 9H |
| CB | Very | Very | Large | Medium |
| Filler | Small | Small | Crack | Crack |
| | Crack | Crack | | |

^{a}ASTM D1149 Method A, Procedure A1: Specimens exposed 72 hrs. @ 50 pphm @ 40° C. @ 0-25% elongation @ 0.5 Hz. Observation made at 7× magnification.

TABLE 7
Ozone Resistance, ASTM D 1149 Method B, Procedure B2^{b}

| Filler | Comparative | Example | Comparative | Example |
|---|---|---|---|---|
| Material | Example 9A | 9B | Example 9C | 9D |
| Silica | Medium | Small | Large | Medium |
| Filler | Crack | Crack | Crack | Crack |
| Filler | Comparative | Example | Comparative | Example |
| Material | Example 9E | 9F | Example 9G | 9H |
| CB | Very | No | Large | Large |
| Filler | Small | Obvious | Crack | Crack |
| | Crack | Crack | | |

^{b}ASTM D 1149 Method B, Procedure B2: Specimens exposed 72 hrs. @ 50 pphm @ 40° C. @20% elongation. Observation made at 7× magnification.

TABLE 6 and TABLE 7 showed that when rubber compositions were tested with Method A, large cracks and broken samples were observed for both compositions containing silica filler and CB filler when the sample was prepared in the absence of 6PPD and the silane compound of Example 1 (Comparative Example 9C and Comparative Example 9G). The sample containing the silane compound of Example 1 showed medium crack (Example 9D) compared to the small crack in control sample (Comparative Example 9A) which contained the conventional antidegradant 6PPD.

When the rubber compositions containing the silica filler were tested with Method B, both the samples mixed with the conventional 6PPD antidegradent and the silane compound of Example 1 showed medium crack (Example 9B and Example 9D). In the case where carbon black filler was in the composition, the sample prepared in the absence of both 6PPD and the silane compound of Example 1 showed large crack and broken samples (Comparative Example 9G). In the presence of 6PPD, very small cracks or no cracking were observed whether or not the silane compound of Example 1 was incorporated.

### 11.2 Leaching Experiment

General procedure: About 4.0 g of cured rubber compounds after the ozone exposure were cut into small pieces (less than 5 mm diameter) and placed into the extraction Thimble. Each rubber compound was under soxhlet exaction with acetone as solvent for 16 hours. When the extraction was done, acetone was removed, and the residue was analyzed by GC/MS and LC/MS. The Results are summarized in TABLE 8.

TABLE 8
Leeching Experiment

| | | Silane Compound | Silane Compound |
|---|---|---|---|
| | 6PPD | of Example 1 | of Example 1 |
| Sample | detected* | detected | species detected |
| Comparative | 100%* | No | No |
| Example 9A | | | |
| Example 9B | 156% | No | No |
| Comparative | 0 | No | No |
| Example 9C | | | |
| Example 9D | 17.6% | No | No |
| Comparative | 100%* | No | No |
| Example 9E | | | |
| Example 9F | 116% | No | No |
| Comparative | — | — | — |
| Example 9G | | | |
| Example 9H | 26.2% | No | No |

*The amount of 6PPD detected by GC is relative to Comparative Example 9A in the case of silica filler. The amount of 6PPD detected by GC is also relative to Comparative Example 9E in the case of carbon black filler.

### Example 12. Preparation of Rubber Components with Impact of Order of Addition

03881 The rubber preparation method of Example 9 was repeated with a first portion of the silane compound of Example 1 added during the NP1 step and a second portion of the silane compound of Example 1 added during the NP2 step. In Example 9, the entire portion of the silane compound of Example 1 was added during the NP1 step so this tested the impact of the order of addition on the properties of the resultant rubber compositions.

TABLE 9
Components of Prepared Rubber for Order of Addition

| | Comparative | Example 1 | Example 1 | Example 1 | Example 1 | Example 1 |
|---|---|---|---|---|---|---|
| | Control A | (100% in | (33%/67% | (50%/50% | (67%/33% | (100% in |
| | (Control 1) | NP1) | NP1/NP2) | NP1/NP2) | NP1/NP2) | NP2) |
| BUNA VSL | 103.1 | 103.1 | 103.1 | 103.1 | 103.1 | 103.1 |
| 4526-2 HM¹ | | | | | | |
| BUNA CB 24² | 25 | 25 | 25 | 25 | 25 | 25 |
| Zeosil 1165MP³ | 80 | 80 | 80 | 80 | 80 | 80 |
| N330 CB⁴ | 10 | 10 | 7 | 7 | 7 | 7 |
| MES⁵ | 5 | 5 | 5 | 5 | 5 | 5 |
| 6PPD⁶ | 2 | | | | | |
| MC Wax⁷ | 0.5 | 0.5 | 0.5 | 0.5 | 0.5 | 0.5 |
| ZnO⁸ | 1.5 | 1.5 | 1.5 | 1.5 | 1.5 | 1.5 |
| Stearic Acid⁹ | 1 | 1 | 1 | 1 | 1 | 1 |
| NXT* Silane¹⁰ | 2 | 2 | 2 | 2 | 2 | 2 |
| Example 1 Silane¹¹ | 6.4 | 6.4 | 6.4 | 6.4 | 6.4 | 6.4 |
| 6PPD⁶ | | 3.8 | 2.5 | 1.9 | 1.3 | |
| NP1 Total | 236.5 | 238.3 | 234 | 233.4 | 232.8 | 231.5 |
| N330 CB | | | 3 | 3 | 3 | 3 |
| Example 1 Silane | | | 1.3 | 1.9 | 2.5 | 3.8 |
| NP2 Total | 236.5 | 238.3 | 238.3 | 238.3 | 238.3 | 238.3 |
| ZNO AZO-66T | 1.5 | 1.5 | 1.5 | 1.5 | 1.5 | 1.5 |
| Sulfur¹² | 2.1 | 2.1 | 2.1 | 2.1 | 2.1 | 2.1 |
| CBS¹³ | 2.1 | 2.1 | 2.1 | 2.1 | 2.1 | 2.1 |
| DPG¹⁴ | 1.5 | 1.5 | 1.5 | 1.5 | 1.5 | 1.5 |
| FM Total | 243.7 | 245.5 | 245.5 | 245.5 | 245.5 | 245.5 |

Components 1-4 and 6-14 of Table 9 are as described in Table 2 of Example 9; 5. The MEA oil used in this study was Vivatec 200 from H&R Group.

### Example 13. Testing Results of Rubber Compositions Impacted by Order of Addition

The test procedures for evaluating the vulcanized (cured) rubber compositions herein are described using the methods described in Table 1. Tables 10, 11, and 12 summarize processing properties, physical properties, and dynamic properties of each of the six rubber compositions listed in Table 10.

The results showed that when shifting a portion of the silane compound of Example 1 added from step one (NP1) to step two (NP2) of the addition process of Example 9, an improvement in rolling resistance and an improvement in wear were observed.

TABLE 10
Processing Properties of Prepared Rubber for Order of Addition

| | | | | | | | |
|---|---|---|---|---|---|---|---|
| | | Comparative | Example 1 | Example 1 | Example 1 | Example 1 | Example 1 |
| Processing | | Control A | (100% in | (33%/67% | (50%/50% | (67%/33% | (100% in |
| Properties | Units | (Control 1) | NP1) | NP1/NP2) | NP1/NP2) | NP1/NP2) | NP2) |

Mooney Viscosity

| | | | | | | | |
|---|---|---|---|---|---|---|---|
| MB1 CMS1 + | MU | N/A | 121 | 121 | 129 | 136 | 164 |
| 4 (100° C.) | | | | | | | |
| MB2 CMS1 + | MU | 106 | 99 | 103 | 109 | 117 | 174 |
| 4 (100° C.) | | | | | | | |
| FM CML1 + | MU | 74 | 72 | 74 | 75 | 77 | 84 |
| 4 (100° C.) | | | | | | | |

Mooney Scorch @ 135° C.

| | | | | | | | |
|---|---|---|---|---|---|---|---|
| Small Rotor | min | 18 | 19 | 20 | 20 | 20 | 20 |
| 3 pt rise | | | | | | | |
| Small Rotor | min | 23 | 24 | 26 | 26 | 25 | 24 |
| 10 pt rise | | | | | | | |

MDR @ 160° C., 30 Min.

| | | | | | | | |
|---|---|---|---|---|---|---|---|
| MIN Torque | dNm | 3 | 24 | 2 | 2 | 3 | 3 |
| MAX Torque | dNm | 21 | 18 | 18 | 18 | 18 | 18 |
| Δ Torque | dNm | 18 | 16 | 16 | 15 | 15 | 15 |
| T10 | min | 3 | 4 | 4 | 4 | 4 | 4 |
| T40 | min | 5 | 5 | 6 | 6 | 5 | 5 |
| T90 | min | 12 | 12 | 12 | 12 | 12 | 11 |
| T95 | min | 17 | 16 | 16 | 16 | 16 | 15 |

TABLE 11
Physical Properties of Prepared Rubber for Order of Addition

| | | Comparative | Example 1 | Example 1 | Example 1 | Example 1 | Example 1 |
|---|---|---|---|---|---|---|---|
| Physical | | Control A | (100% in | (33%/67% | (50%/50% | (67%/33% | (100% in |
| Properties | Units | (Control 1) | NP1) | NP1/NP2) | NP1/NP2) | NP1/NP2) | NP2) |
| Specific Gravity | g/cm3 | 1.18 | 1.19 | 1.19 | 1.19 | 1.19 | 1.19 |
| 50% Modulus | MPa | 1.4 | 1.4 | 1.4 | 1.3 | 1.3 | 1.4 |
| 100% Modulus | MPa | 2.6 | 2.6 | 2.5 | 2.5 | 2.5 | 2.6 |
| 200% Modulus | MPa | 6.6 | 6.6 | 6.6 | 6.7 | 6.7 | 7.2 |
| 300% Modulus | MPa | 11.9 | 11.8 | 11.9 | 12.2 | 12.2 | 13.3 |
| RI (M300/M100) | | 4.7 | 4.6 | 4.7 | 4.8 | 4.9 | 5.2 |
| Tensile | MPa | 15.4 | 14.9 | 16.6 | 16 | 16.9 | 16.4 |
| Elongation | % | 396 | 390.9 | 422.4 | 402 | 418.3 | 381.2 |
| Shore A @ 25° C. | shoreA | 66 | 65.4 | 64.9 | 64.2 | 64.1 | 63.8 |
| Shore A @ 70° C. | shoreA | 64 | 62.9 | 62.7 | 62.6 | 62.2 | 62 |
| FtF (Fatigue to Failure) | KC | 313 | 302 | 221 | 213 | 232 | 95 |
| DIN Abrasion | mm3 | 109 | 120 | 118 | 114 | 113 | 107 |

TABLE 12
Dynamic Properties of Prepared Rubber for Order of Addition

| | | | | | | | |
|---|---|---|---|---|---|---|---|
| | | Comparative | Example 1 | Example 1 | Example 1 | Example 1 | Example 1 |
| Dynamic | | Control A | (100% in | (33%/67% | (50%/50% | (67%/33% | (100% in |
| Properties | Units | (Control 1) | NP1) | NP1/NP2) | NP1/NP2) | NP1/NP2) | NP2) |

Rebound

| | | | | | | | |
|---|---|---|---|---|---|---|---|
| 0° C. | % | 14 | 14 | 14 | 17 | 18 | 19 |
| 25° C. | % | 28 | 26 | 26 | 27 | 27 | 28 |
| 70° C. | % | 51 | 51 | 51 | 52 | 51 | 53 |
| 100° C. | % | 58 | 58 | 59 | 59 | 59 | 60 |

RPA 2000 - Strain Sweep @ 60° C.

| | | | | | | | |
|---|---|---|---|---|---|---|---|
| G′ @ 2% | MPa | 2.5 | 3.3 | 3.3 | 3.2 | 3.2 | 3.1 |
| G′ @ 5% | MPa | 2.0 | 2.4 | 2.4 | 2.4 | 2.5 | 2.4 |
| G′ @ 10% | MPa | 1.6 | 1.9 | 1.9 | 2.0 | 2.0 | 2.0 |
| Tan δ @ 2% | | 0.132 | 0.107 | 0.095 | 0.086 | 0.085 | 0.074 |
| Tan δ @ 5% | | 0.149 | 0.128 | 0.117 | 0.104 | 0.102 | 0.087 |
| Tan δ @ 10% | | 0.146 | 0.142 | 0.129 | 0.108 | 0.103 | 0.086 |

Metravib - Strain Sweep

| | | | | | | | |
|---|---|---|---|---|---|---|---|
| G′ @ 0.1% | MPa | 3.6 | 3.7 | 3.2 | 3.4 | 3.3 | 3.2 |
| G′ @ 10% | MPa | 1.7 | 1.6 | 1.5 | 1.6 | 1.6 | 1.6 |
| Δ G′ (Payne Effect) | MPa | 1.9 | 2.1 | 1.7 | 1.8 | 1.7 | 1.6 |
| Tan δ max | | 0.150 | 0.180 | 0.174 | 0.164 | 0.164 | 0.153 |

Metravib - Temperature Sweep

| | | | | | | |
|---|---|---|---|---|---|---|
| Tan δ @ 60° C. | 0.151 | 0.174 | 0.166 | 0.159 | 0.161 | 0.148 |
| Tan δ @ Tg | 0.578 | 0.551 | 0.575 | 0.568 | 0.566 | 0.592 |
| Tan δ @ 0° C. | 0.357 | 0.363 | 0.383 | 0.378 | 0.371 | 0.391 |

### Example 14

The rubber preparation method of Example 9 was repeated with a first portion of the silane compound of Example 1 added during the NP1 step and no 6PPD added during the NPL1 step (see Compounds 1-4) as shown in Table 13. During the NP2 step, a second portion of the silane compound of Example 1 was added 1 (see Compounds 2-5). In Example 9, the entire portion of the silane compound of Example 1 was added during the NP1 step so this not only tested the impact of the order of addition but also tested whether the silane compound of Example 1 could be used to replace 6PPD.

Tables 14, 15, and 16 summarize processing properties, physical properties, and dynamic properties of each of the four rubber compositions listed in Table 13. The compound results showed that when shifting the amount of the silane compound of Example 1 from the first mixing step (NP1) to the second mixing step (NP2), an improvement in rolling resistance and an improvement in wear were observed.

TABLE 13
Components of Prepared Rubber for Order of Addition

| | Comparative | Compound 1 | Compound 2 | Compound 3 | Compound 4 | Compound 5 |
|---|---|---|---|---|---|---|
| | Control A | (100% in | (33%/67% | (50%/50% | (67%/33% | (100% in |
| | (Control 1) | NP1) | NP1/NP2) | NP1/NP2) | NP1/NP2) | NP2) |
| BUNA VSL | 103.1 | 103.1 | 103.1 | 103.1 | 103.1 | 103.1 |
| 4526-2 HM¹ | | | | | | |
| BUNA CB 24² | 25 | 25 | 25 | 25 | 25 | 25 |
| Zeosil 1165MP³ | 80 | 80 | 80 | 80 | 80 | 80 |
| N330 CB⁴ | 10 | 10 | 7 | 7 | 7 | 7 |
| MES⁵ | 5 | 5 | 5 | 5 | 5 | 5 |
| 6PPD⁶ | 2 | | | | | |
| TMQ⁷ | 0.5 | 0.5 | 0.5 | 0.5 | 0.5 | 0.5 |
| MC Wax⁸ | 1.5 | 1.5 | 1.5 | 1.5 | 1.5 | 1.5 |
| ZnO⁹ | 1 | 1 | 1 | 1 | 1 | 1 |
| Stearic Acid¹⁰ | 2 | 2 | 2 | 2 | 2 | 2 |
| NXT* Silane¹¹ | 6.4 | 6.4 | 6.4 | 6.4 | 6.4 | 6.4 |
| Example 1 Silane¹² | | 3.8 | 2.5 | 1.9 | 1.3 | |
| NP1 Total | 236.5 | 238.3 | 234 | 233.4 | 232.8 | 231.5 |
| N330 CB | | | 3 | 3 | 3 | 3 |
| Example 1 Silane | | | 1.3 | 1.9 | 2.5 | 3.8 |
| NP2 Total | 236.5 | 238.3 | 238.3 | 238.3 | 238.3 | 238.3 |
| ZNO AZO-66T | 1.5 | 1.5 | 1.5 | 1.5 | 1.5 | 1.5 |
| Sulfur¹³ | 2.1 | 2.1 | 2.1 | 2.1 | 2.1 | 2.1 |
| CBS¹⁴ | 2.1 | 2.1 | 2.1 | 2.1 | 2.1 | 2.1 |
| DPG¹⁵ | 1.5 | 1.5 | 1.5 | 1.5 | 1.5 | 1.5 |
| FM Total | 243.7 | 245.5 | 245.5 | 245.5 | 245.5 | 245.5 |

Components 1-6 and 8-13 (listed as 7-12 in Table 2) of Table 13 are as described in Table 2 of Example 9;
7. TMQ (poly(1,2-hydro-2,2,4-trimethylquinoline) used in this study was from HB Chemical.

### Example 15. Testing Results of Rubber Compositions to Optimize Anti-Ozone Package

The test procedures for evaluating the vulcanized (cured) rubber compositions herein are described using the methods described in Table 1. Tables 14, 15, and 16 summarize processing properties, physical properties, and dynamic properties of each of the four rubber compositions listed in Table 13.

The results showed that when shifting a portion of the silane compound of Example 1 added from step one (NP1) to step two (NP2) of the addition process of Example 9, an improvement in rolling resistance and an improvement in wear were observed.

TABLE 14
Processing Properties of Prepared Rubber for Order of Addition

| | | | | | | | |
|---|---|---|---|---|---|---|---|
| | | Comparative | Compound 1 | Compound 2 | Compound 3 | Compound 4 | Compound 5 |
| Processing | | Control A | (100% in | (33%/67% | (50%/50% | (67%/33% | (100% in |
| Properties | Units | (Control 1) | NP1) | NP1/NP2) | NP1/NP2) | NP1/NP2) | NP2) |

Mooney Viscosity

| | | | | | | | |
|---|---|---|---|---|---|---|---|
| MB1 CMS1 + | MU | N/A | 121 | 121 | 129 | 136 | 164 |
| 4(100° C.) | | | | | | | |
| MB2 CMS1 + | MU | 106 | 99 | 103 | 109 | 117 | 174 |
| 4(100° C.) | | | | | | | |
| FM CML1 + | MU | 74 | 72 | 74 | 75 | 77 | 84 |
| 4(100° C.) | | | | | | | |

Mooney Scorch @ 135° C.

| | | | | | | | |
|---|---|---|---|---|---|---|---|
| Small Rotor | min | 18 | 19 | 20 | 20 | 20 | 20 |
| 3 pt rise | | | | | | | |
| Small Rotor | min | 23 | 24 | 26 | 26 | 25 | 24 |
| 10 pt rise | | | | | | | |

MDR @ 160° C., 30 Min.

| | | | | | | | |
|---|---|---|---|---|---|---|---|
| MIN Torque | dNm | 3 | 2 | 2 | 2 | 3 | 3 |
| MAX Torque | dNm | 21 | 18 | 18 | 18 | 18 | 18 |
| Δ Torque | dNm | 18 | 16 | 16 | 15 | 15 | 15 |
| T10 | min | 3 | 4 | 4 | 4 | 4 | 4 |
| T40 | min | 5 | 5 | 6 | 6 | 5 | 5 |
| T90 | min | 12 | 12 | 12 | 12 | 12 | 11 |
| T95 | min | 17 | 16 | 16 | 16 | 16 | 15 |

TABLE 15
Physical Properties of Prepared Rubber for Order of Addition

| | | Comparative | Compound 1 | Compound 2 | Compound 3 | Compound 4 | Compound 5 |
|---|---|---|---|---|---|---|---|
| Physical | | Control A | (100% in | (33%/67% | (50%/50% | (67%/33% | (100% in |
| Properties | Units | (Control 1) | NP1) | NP1/NP2) | NP1/NP2) | NP1/NP2) | NP2) |
| Specific Gravity | g/cm3 | 1.18 | 1.19 | 1.19 | 1.19 | 1.19 | 1.19 |
| 50% Modulus | MPa | 1.4 | 1.4 | 1.4 | 1.3 | 1.3 | 1.4 |
| 100% Modulus | MPa | 2.6 | 2.6 | 2.5 | 2.5 | 2.5 | 2.6 |
| 200% Modulus | MPa | 6.6 | 6.6 | 6.6 | 6.7 | 6.7 | 7.2 |
| 300% Modulus | MPa | 11.9 | 11.8 | 11.9 | 12.2 | 12.2 | 13.3 |
| RI (M300/M100) | | 4.7 | 4.6 | 4.7 | 4.8 | 4.9 | 5.2 |
| Tensile | MPa | 15.4 | 14.9 | 16.6 | 16 | 16.9 | 16.4 |
| Elongation | % | 396 | 390.9 | 422.4 | 402 | 418.3 | 381.2 |
| Shore A @ 25° C. | shoreA | 66 | 65.4 | 64.9 | 64.2 | 64.1 | 63.8 |
| Shore A @ 70° C. | shoreA | 64 | 62.9 | 62.7 | 62.6 | 62.2 | 62 |
| FtF (Fatigue to Failure) | KC | 313 | 302 | 221 | 213 | 232 | 95 |
| DIN Abrasion | mm3 | 109 | 120 | 118 | 114 | 113 | 107 |

TABLE 16
Dynamic Properties of Prepared Rubber for Order of Addition

| | | | | | | | |
|---|---|---|---|---|---|---|---|
| | | Comparative | Compound 1 | Compound 2 | Compound 3 | Compound 4 | Compound 5 |
| Dynamic | | Control A | (100% in | (33%/67% | (50%/50% | (67%/33% | (100% in |
| Properties | Units | (Control 1) | NP1) | NP1/NP2) | NP1/NP2) | NP1/NP2) | NP2) |

Rebound

| | | | | | | | |
|---|---|---|---|---|---|---|---|
| 0° C. | % | 14 | 14 | 14 | 17 | 18 | 19 |
| 25° C. | % | 28 | 26 | 26 | 27 | 27 | 28 |
| 70° C. | % | 51 | 51 | 51 | 52 | 51 | 53 |
| 100° C. | % | 58 | 58 | 59 | 59 | 59 | 60 |

RPA 2000 - Strain Sweep @ 60° C.

| | | | | | | | |
|---|---|---|---|---|---|---|---|
| G′ @ 2% | MPa | 2.5 | 3.3 | 3.3 | 3.2 | 3.2 | 3.1 |
| G′ @ 5% | MPa | 2.0 | 2.4 | 2.4 | 2.4 | 2.5 | 2.4 |
| G′ @ 10% | MPa | 1.6 | 1.9 | 1.9 | 2.0 | 2.0 | 2.0 |
| Tan δ @ 2% | | 0.132 | 0.107 | 0.095 | 0.086 | 0.085 | 0.074 |
| Tan δ @ 5% | | 0.149 | 0.128 | 0.117 | 0.104 | 0.102 | 0.087 |
| Tan δ @ 10% | | 0.146 | 0.142 | 0.129 | 0.108 | 0.103 | 0.086 |

Metravib - Strain Sweep

| | | | | | | | |
|---|---|---|---|---|---|---|---|
| G′ @ 0.1% | MPa | 3.6 | 3.7 | 3.2 | 3.4 | 3.3 | 3.2 |
| G′ @ 10% | MPa | 1.7 | 1.6 | 1.5 | 1.6 | 1.6 | 1.6 |
| Δ G′ (Payne Effect) | MPa | 1.9 | 2.1 | 1.7 | 1.8 | 1.7 | 1.6 |
| Tan δ max | | 0.150 | 0.180 | 0.174 | 0.164 | 0.164 | 0.153 |

Metravib - Temperature Sweep

| | | | | | | |
|---|---|---|---|---|---|---|
| Tan δ @ 60° C. | 0.151 | 0.174 | 0.166 | 0.159 | 0.161 | 0.148 |
| Tan δ @ Tg | 0.578 | 0.551 | 0.575 | 0.568 | 0.566 | 0.592 |
| Tan δ @ 0° C. | 0.357 | 0.363 | 0.383 | 0.378 | 0.371 | 0.391 |

### Example 16. Method to Manufacture the Rubber Composition when Utilizing Example 1 Anti-Ozonate

The rubber composition preparation method of Example 9 was repeated with the silane compound of Example 1 added during the first mixing step (NP1) and/or the second mixing step (NP2) as shown in Table 17.

Results were summarized from the overall properties shown in Table 18, Table 19, and Table 20. Tables 18, 19, and 20 show that after ozone exposure, comparable results were obtained with compounds comprising the silane compound of Example 1 and a small amount of 7PPD (Compounds 6-9) compared to the results obtained with Comparative Control A prepared with 6PPD instead of the silane compound of Example 1 based on static and dynamic ozone results.

TABLE 17
Components of Prepared Rubber for Optimizing Anti-Ozone Package

| | Comparative | | Compound 7 | Compound 8 | Compound 9 |
|---|---|---|---|---|---|
| | Control A | Compound 6 | (+25% 7PPD + | (+25% 7PPD + | (+50% 7PPD + |
| | (Control 1) | (+25% 7PPD) | 5% Wax) | 10% Wax) | 10% Wax) |
| S-SBR¹ | 120 | 120 | 120 | 120 | 120 |
| BUNA CB 24² | 25 | 25 | 25 | 25 | 25 |
| Zeosil 1165MP³ | 80 | 80 | 80 | 80 | 80 |
| N330 CB⁴ | 10 | 10 | 10 | 10 | 10 |
| 6PPD⁵ | 2 | | | | |
| TMQ⁶ | 0.5 | 0.5 | 0.5 | 0.5 | 0.5 |
| MC Wax⁷ | 1.5 | 1.5 | 1.6 | 1.7 | 1.7 |
| ZnO⁸ | 2.5 | 2.5 | 2.5 | 2.5 | 2.5 |
| Stearic Acid⁹ | 2.0 | 2.0 | 2.0 | 2.0 | 2.0 |
| NXT* Silane¹⁰ | 6.4 | 6.4 | 6.4 | 6.4 | 6.4 |
| 7PPD¹¹ | | 0.5 | 0.5 | 0.5 | 1.1 |
| Example 1 | | 3.8 | 3.8 | 3.8 | 3.8 |
| Anti-Ozonate¹² | | | | | |
| Sulfur¹³ | 1.8 | 1.8 | 1.8 | 1.8 | 1.8 |
| CBS¹⁴ | 2.1 | 2.1 | 2.1 | 2.1 | 2.1 |
| DPG¹⁵ | 1.5 | 1.5 | 1.5 | 1.5 | 1.5 |
| Total PHR | 255.3 | 257.6 | 257.7 | 257.8 | 258.4 |

¹Nonfunctionalized, Oil Extended S-SBR (styrene butadiene rubber);
Components ²-⁵ (listed as 2, 3, 4, and 6 in Table 2) are as described in Table 2 of Example 9;
⁶TMQ (poly(1,2-hydro-2,2,4-trimethylquinoline) used in this study was from HB Chemical;
Components ⁷-¹⁰ (listed as 8-11 in Table 2) are as described in Table 2 of Example 9;
¹¹7PPD used in this study was Santoflex ® 7PPD sourced from Flexsys is a rubber staining antiozonant and antioxidant;
Components ¹²-¹⁵ (listed as 12-15 in Table 2) are as described in Table 2 of Example 9.

### Example 17. Testing Results of Rubber Compositions to Optimize Anti-Ozone Package

The test procedures for evaluating the vulcanized (cured) rubber compositions herein are described using the methods described in Table 1. Tables 18, 19, and 20 summarize processing properties, physical properties, and dynamic properties of each of the five rubber compositions listed in Table 17.

Tables 18, 19, and 20 show that after ozone exposure, comparable results were obtained with compounds comprising the silane compound of Example 1 and a small amount of 7PPD (Compounds 6-9) compared to the results obtained with Comparative Control A comprising 6PPD instead of the silane compound of Example 1 based on static and dynamic ozone results.

TABLE 18
Processing Properties of Prepared Rubber for Optimizing Anti-Ozone Package

| | | | | | | |
|---|---|---|---|---|---|---|
| | | Comparative | | Compound 7 | Compound 8 | Compound 9 |
| Processing | | Control A | Compound 6 | (+25% 7PPD + | (+25% 7PPD + | (+50% 7PPD + |
| Properties | Units | (Control 1) | (+25% 7PPD) | 5% Wax) | 10% Wax) | 10% Wax) |

Mooney Viscosity

| | | | | | | |
|---|---|---|---|---|---|---|
| MB1 CMS1 + | MU | NEC | 130 | 129 | 128 | 130 |
| 4(100° C.) | | | | | | |
| MB2 CMS1 + | MU | 133 | 124 | 122 | 123 | 124 |
| 4(100° C.) | | | | | | |
| FM CML1 + | MU | 106 | 98 | 96 | 97 | 98 |
| 4(100° C.) | | | | | | |

Mooney Scorch @ 135° C.

| | | | | | | |
|---|---|---|---|---|---|---|
| Small Rotor | min | 20 | 21 | 22 | 22 | 21 |
| 3 pt rise | | | | | | |
| Small Rotor | min | 25 | 27 | 26 | 27 | 26 |
| 10 pt rise | | | | | | |

MDR @ 160° C., 30 Min.

| | | | | | | |
|---|---|---|---|---|---|---|
| MIN Torque | dNm | 4 | 4 | 3 | 4 | 4 |
| MAX Torque | dNm | 22 | 18 | 18 | 18 | 18 |
| Δ Torque | dNm | 17 | 15 | 14 | 15 | 15 |
| T10 | min | 4 | 4 | 4 | 4 | 4 |
| T40 | min | 6 | 6 | 6 | 6 | 6 |
| T90 | min | 12 | 11 | 10 | 11 | 11 |
| T95 | min | 17 | 14 | 14 | 14 | 14 |

TABLE 19
Physical Properties of Prepared Rubber for Optimizing Anti-Ozone Package

| | | Comparative | | Compound 7 | Compound 8 | Compound 9 |
|---|---|---|---|---|---|---|
| Physical | | Control A | Compound 6 | (+25% 7PPD + | (+25%7PPD + | (+50% 7PPD + |
| Properties | Units | (Control 1) | (+25% 7PPD) | 5% Wax) | 10% Wax) | 10% Wax) |
| Specific Gravity | g/cm3 | 1.18 | 1.18 | 1.19 | 1.18 | 1.18 |
| 50% Modulus | MPa | 1.3 | 1.3 | 1.3 | 1.3 | 1.3 |
| 100% Modulus | MPa | 2.1 | 2.2 | 2.2 | 2.1 | 2.1 |
| 200% Modulus | MPa | 5.3 | 5.5 | 5.4 | 5.3 | 5.3 |
| 300% Modulus | MPa | 10.0 | 10.3 | 10.0 | 9.9 | 9.9 |
| RI (M300/M100) | None | 4.8 | 4.7 | 4.7 | 4.7 | 4.7 |
| Tensile | MPa | 18.4 | 14.7 | 18.3 | 13.4 | 16.1 |
| Elongation | % | 506 | 424 | 510 | 403 | 466 |
| Shore A @ 25° C. | shoreA | 61.3 | 61.3 | 61.6 | 61.9 | 61.0 |
| Shore A @ 70° C. | shoreA | 60.9 | 60.1 | 60.0 | 60.2 | 60.4 |
| DIN Abrasion | mm3 | 77 | 85 | 84 | 84 | 84 |

TABLE 20
Dynamic Properties of Prepared Rubber for Optimizing Anti-Ozone Package

| | | | | | | |
|---|---|---|---|---|---|---|
| | | Comparative | | Compound 7 | Compound 8 | Compound 9 |
| Dynamic | | Control A | Compound 6 | (+25% 7PPD + | (+25% 7PPD + | (+50% 7PPD + |
| Properties | Units | (Control 1) | (+25% 7PPD) | 5% Wax) | 10% Wax) | 10% Wax) |

Rebound

| | | | | | | |
|---|---|---|---|---|---|---|
| 0° C. | % | 13 | 12 | 13 | 13 | 15 |
| 25° C. | % | 30 | 29 | 28 | 29 | 28 |
| 70° C. | % | 53 | 53 | 53 | 54 | 53 |
| 100° C. | % | 58 | 59 | 58 | 59 | 59 |

RPA 2000 - Strain Sweep @ 60° C.

| | | | | | | |
|---|---|---|---|---|---|---|
| G′ @ 2% | MPa | 4.6 | 3.4 | 3.3 | 3.3 | 3.3 |
| G′ @ 5% | MPa | 3.4 | 2.6 | 2.6 | 2.6 | 2.4 |
| G′ @ 10% | MPa | 2.4 | 2.0 | 2.0 | 2.0 | 1.8 |
| Tan δ @ 2% | | 0.072 | 0.078 | 0.077 | 0.076 | 0.088 |
| Tan δ @ 5% | | 0.094 | 0.091 | 0.091 | 0.089 | 0.109 |
| Tan δ @ 10% | | 0.109 | 0.095 | 0.094 | 0.094 | 0.116 |

Metravib - Strain Sweep

| | | | | | | |
|---|---|---|---|---|---|---|
| G′ @ 0.1% | MPa | 4.1 | 3.2 | 2.8 | 3.3 | 3.2 |
| G′ @ 10% | MPa | 1.9 | 1.6 | 1.4 | 1.6 | 1.6 |
| Δ G′ (Payne Effect) | MPa | 2.2 | 1.6 | 1.4 | 1.7 | 1.6 |
| Tan δ max | | 0.149 | 0.155 | 0.162 | 0.158 | 0.153 |

Metravib - Temperature Sweep

| | | | | | |
|---|---|---|---|---|---|
| Tan δ @ 60° C. | 0.149 | 0.161 | 0.178 | 0.161 | 0.158 |
| Tan δ @ Tg | 0.757 | 0.829 | 0.765 | 0.748 | 0.756 |
| Tan δ @ 0° C. | 0.375 | 0.558 | 0.500 | 0.405 | 0.386 |

### OTHER ASPECTS

All publications, patents, and patent applications mentioned in this specification are incorporated herein by reference in their entirety to the same extent as if each individual publication, patent, or patent application was specifically and individually indicated to be incorporated by reference in its entirety. Where a term in the present application is found to be defined differently in a document incorporated herein by reference, the definition provided herein is to serve as the definition for the term.

While the invention has been described in connection with specific aspects thereof, it will be understood that the invention is capable of further modifications and this application is intended to cover any variations, uses, or adaptations of the invention following, in general, the principles of the invention and including such departures from the present disclosure that come within known or customary practice within the art to which the invention pertains and can be applied to the essential features hereinbefore set forth, and follows in the scope of the claimed invention.

1. A silane compound, wherein the compound is:
(i) a phenylenediamine of Formula (I): 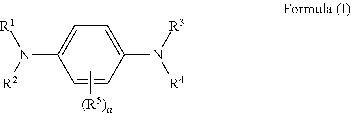
wherein
R¹, R², R³, and R⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, or L₁X₁X₂SiR⁶R⁷R⁸, wherein the heteroatom is N, O, or S;
each R⁵ is independently L₁X₁X₂SiR⁶R⁷R⁸;
a is 0, 1, 2, 3, or 4;
each L₁ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₁ is —C(═O)—, —C(═O)—O—, —C(═O)—N—, or is absent;
X₂ is an optionally substituted alkylene group having from 1 to 20 carbon atoms and optionally at least one heteroatom, wherein the heteroatom is N, O, or S, or is absent;
R⁶, R⁷, and R⁸ are each independently —OR⁹, —R¹⁰, or —OC(═O)R¹¹;
R⁹, R¹⁰, and R¹¹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
at least one of R¹, R², R³, R⁴, and R⁵ is L₁X₁X₂SiR⁶R⁷R⁸; or
(ii) a quinone diimine of Formula (II): 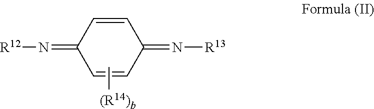
wherein
R¹² and R¹³ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, or L₂X₃X₄SiR¹⁵R¹⁶R¹⁷, wherein the heteroatom is N, O, or S;
each R¹⁴ is independently L₂X₃X₄SiR¹⁵R¹⁶R¹⁷;
b is 0, 1, 2, 3, or 4;
each L₂ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 12 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₃ is —C(═O)—, —C(═O)—O—, —C(═O)—N—, or is absent;
X₄ is an optionally substituted alkylene group having from 1 to 20 carbon atoms and optionally at least one heteroatom, wherein the heteroatom is N, O, or S, or is absent;
R¹⁵, R¹⁶, and R¹⁷ are each independently —OR¹⁸, —R¹⁹, or —OC(═O)R²⁰;
R¹⁸, R¹⁹, and R²⁰ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
at least one of R¹², R¹³, and R¹⁴ is L₂X₃X₄SiR¹⁵R¹⁶R¹⁷; or
(iii) a phenylenediamine of Formula (III): 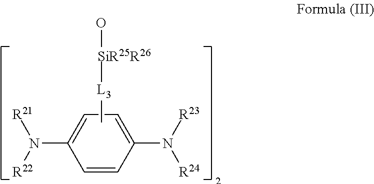
wherein
R²¹, R²², R²³, and R²⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each L₃ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
R²⁵ and R²⁶ are each independently —OR²⁷, —R²⁸, or —OC(═O)R²⁹; and
R²⁷, R²⁸, and R²⁹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

2. The silane compound of claim 1, wherein the compound is a phenylenediamine of Formula (IV): 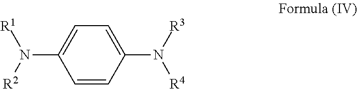
wherein
R¹, R², R³, and R⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, or L₁X₁X₂SiR⁶R⁷R⁸, wherein the heteroatom is N, O, or S;
L₁ is an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₁ is —C(═O)—, —C(═O)—O—, —C(═O)—N—, or is absent;
X₂ is an optionally substituted alkylene group having from 1 to 20 carbon atoms and optionally at least one heteroatom, wherein the heteroatom is N, O, or S, or is absent;
R⁶, R⁷, and R⁸ are each independently —OR⁹, —R¹⁰, or —OC(═O)R¹¹;
R⁹, R¹⁰, and R¹¹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
at least one of R¹, R², R³, or R⁴ is L₁X₁X₂SiR⁶R⁷R⁸.

3. (canceled)

4. The silane compound of claim 2, wherein the silane compound of Formula (IV) is selected from the group consisting of:

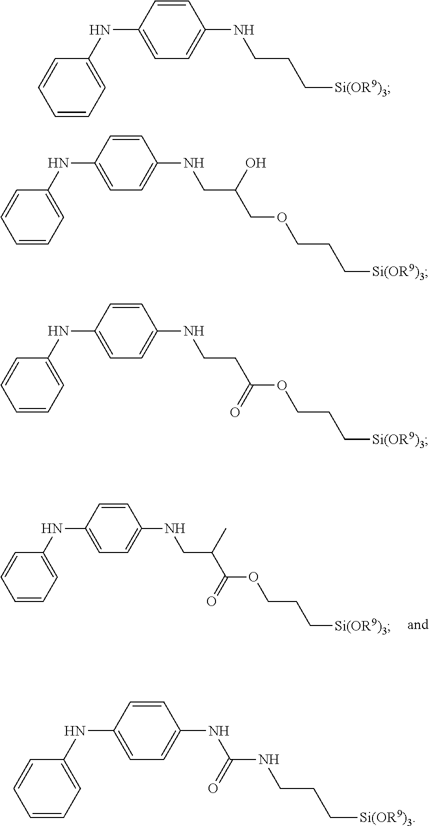

5. The silane compound of claim 1, wherein the silane compound is a phenylenediamine of Formula (V): 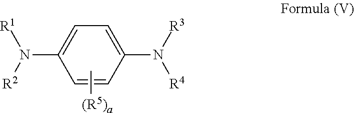
wherein
R¹, R², R³, and R⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each R⁵ is independently L₁X₁X₂SiR⁶R⁷R⁸;
a is 1, 2, 3, or 4;
each L₁ is independently an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₁ is —C(═O)—, —C(═O)—O—, —C(═O)—N—, or is absent;
X₂ is an optionally substituted alkylene group having from 1 to 20 carbon atoms and optionally at least one heteroatom, wherein the heteroatom is N, O, or S, or is absent;
R⁶, R⁷, and R⁸ are each independently —OR⁹, —R¹⁰, or —OC(═O)R¹¹;
R⁹, R¹⁰, and R¹¹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

6. (canceled)

7. (canceled)

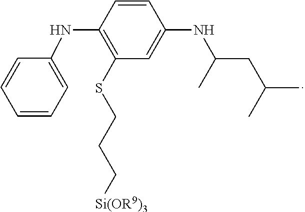

8. The silane compound of claim 1, wherein the compound is a quinone diimine of Formula VI: 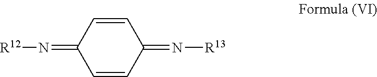
wherein
R¹² and R¹³ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, or L₂X₃X₄SiR¹⁵R¹⁶R¹⁷, wherein the heteroatom is N, O, or S;
each L₂ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₃ is —C(═O)—, —C(═O)—O—, —C(═O)—N—, or is absent;
X₄ is an optionally substituted alkylene group having from 1 to 20 carbon atoms and optionally at least one heteroatom, wherein the heteroatom is N, O, or S, or is absent;
R¹⁵, R¹⁶, and R¹⁷ are each independently —OR¹⁸, —R¹⁹, or —OC(═O)R²⁰;
R¹⁸, R¹⁹, and R²⁰ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
at least one of R¹² and R¹³ is L₂X₃X₄SiR¹⁵R¹⁶R¹⁷.

9. (canceled)

10. The silane compound of claim 8, wherein the silane compound of Formula (VI) is

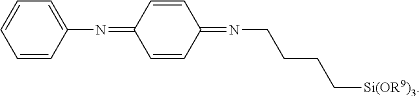

11. The silane compound of claim 1, wherein the compound is a quinone diimine of Formula VII: 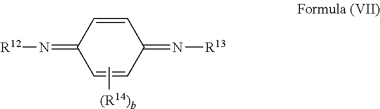
wherein
R¹² and R¹³ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each R¹⁴ is independently L₂X₃X₄SiR¹⁵R¹⁶R¹⁷;
b is 1, 2, 3, or 4;
each L₂ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₃ is —C(═O)—, —C(═O)—O—, —C(═O)—N—, or is absent;
X₄ is an optionally substituted alkylene group having from 1 to 20 carbon atoms and optionally at least one heteroatom, wherein the heteroatom is N, O, or S, or is absent;
R¹⁵, R¹⁶, and R¹⁷ are each independently —OR¹⁸, —R¹⁹, or —OC(═O)R²⁰;
R¹⁸, R¹⁹, and R²⁰ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

12. (canceled)

13. The silane compound of claim 11, wherein the silane compound of Formula (VII) is

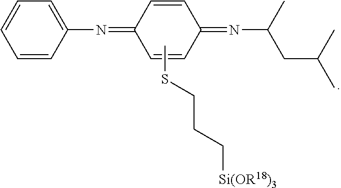

14. The silane compound of claim 1, wherein the compound is a phenylenediamine of Formula (VIII): 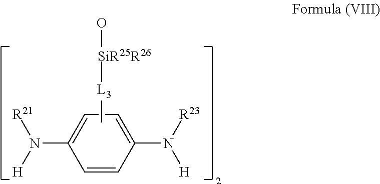
wherein
R²¹ and R²³ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each L₃ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
R²⁵ and R²⁶ are each independently —OR²⁷, —R²⁸, or —OC(═O)R²⁹; and
R²⁷, R²⁸, and R²⁹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

15. The silane compound of claim 14, wherein the silane compound of Formula (VIII) is

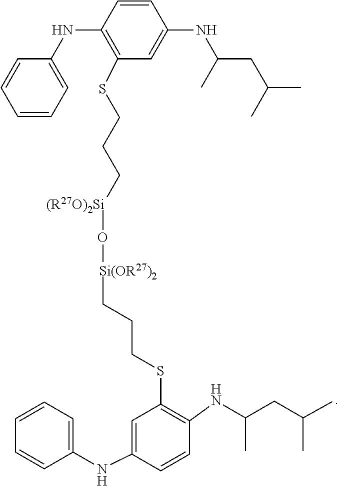

16. A polymer represented by Formula (IX): 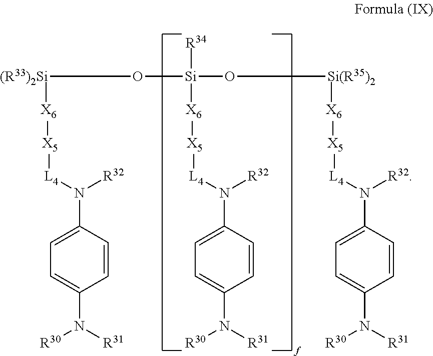
wherein
R³⁰, R³¹, and R³² are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each L₄ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₅ is —C(═O)—, —C(═O)—O—, —C(═O)—N—, or is absent;
X₆ is an optionally substituted alkylene group having from 1 to 20 carbon atoms and optionally at least one heteroatom, wherein the heteroatom is N, O, or S, or is absent;
R³³, R³⁴, and R³⁵ are each independently —OR³⁶, —R³⁷, or —OC(═O)R³⁸; and
R³⁶, R³⁷, and R³⁸ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
f is an integer from 1 to 60.

17. The polymer of claim 16, wherein the polymer of Formula (IX) is 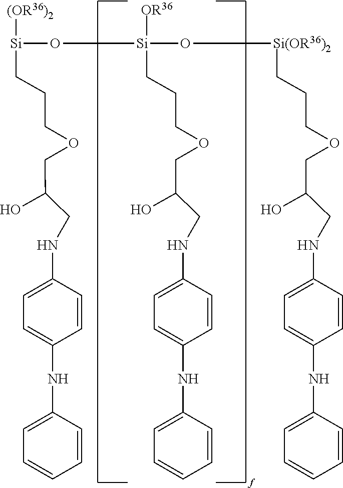
wherein f is an integer from 1 to 60.

18. A method of making a silane compound, wherein the silane compound is:
(i) the phenylenediamine of Formula (IV): 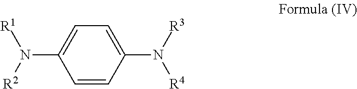
of claim 2 comprising reacting:
a compound of Formula (X): 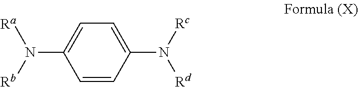
wherein
R^{a}, R^{b}, R^{c}, and R^{d} are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and wherein at least one of R^{a}, R^{b}, R^{c}, and R^{d} is hydrogen;
with a compound of Formula (XI): 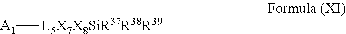
wherein
A₁ is —Cl, —Br, —OH, a glycidoxy group, a methacryloxypropyl group, or an isocyanatopropyl group;
L₅ is an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, wherein the heteroatom is N, O, or S;
X₇ is —C(═O)—, —C(═O)—O—, —C(═O)—N—, or is absent;
X₈ is an optionally substituted alkylene group having from 1 to 20 carbon atoms and optionally at least one heteroatom, wherein the heteroatom is N, O, or S, or is absent;
R³⁷, R³⁸, and R³⁹ are each independently —OR⁴⁰, —R⁴¹, or —OC(═O)R⁴²;
R⁴⁰, R⁴¹, and R⁴² are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; or
(ii) the phenylenediamine of Formula (V): 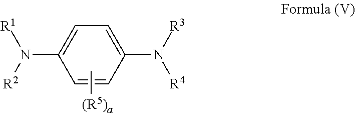
wherein
R¹, R², R³, and R⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each R⁵ is independently L₁X₁X₂SiR⁶R⁷R⁸;
a is 1, 2, 3, or 4;
each L₁ is independently an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₁ is —C(═O)—, —C(═O)—O—, —C(═O)—N—, or is absent;
X₂ is an optionally substituted alkylene group having from 1 to 20 carbon atoms and optionally at least one heteroatom, wherein the heteroatom is N, O, or S, or is absent;
R⁶, R⁷, and R⁸ are each independently —OR⁹, —R¹⁰, or —OC(═O)R¹¹;
R⁹, R¹⁰, and R¹¹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
comprising reacting a compound of Formula (X): 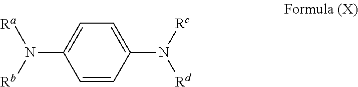
wherein
R^{a}, R^{b}, R^{c}, and R^{d} are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
with an oxidizer, optionally a catalyst, and at least one compound of Formula (XII): 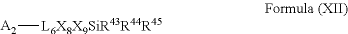
wherein
A₂ is —SH, —NH₂, or —OH;
L₆ is an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, wherein the heteroatom is N, O, or S;
X₈ is —C(═O)—, —C(═O)—O—, —C(═O)—N—, or is absent;
X₉ is an optionally substituted alkylene group having from 1 to 20 carbon atoms and optionally at least one heteroatom, wherein the heteroatom is N, O, or S, or is absent;
R⁴³, R⁴⁴, and R⁴⁵ are each independently —OR⁴⁶, —R⁴⁷, or —OC(═O)R⁴⁸;
R⁴⁶, R⁴⁷, and R⁴⁸ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

19. A method of making a silane compound, wherein the silane compound is:
(i) the quinone diimine of Formula (VI): 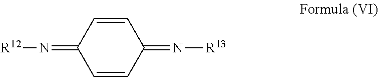
of claim 8 comprising reacting a compound of Formula (IV): 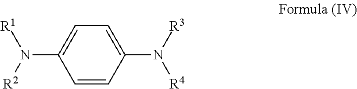
with an oxidizer and optionally a catalyst;
wherein
R¹, R², R³, and R⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, or L₁X₁X₂SiR⁶R⁷R⁸, wherein the heteroatom is N, O, or S;
L₁ is an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₁ is —C(═O)—, —C(═O)—O—, —C(═O)—N—, or is absent;
X₂ is an optionally substituted alkylene group having from 1 to 20 carbon atoms and optionally at least one heteroatom, wherein the heteroatom is N, O, or S, or is absent;
R⁶, R⁷, and R⁸ are each independently —OR⁹, —R¹⁰, or —OC(═O)R¹¹;
R⁹, R¹⁰, and R¹¹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
wherein at least one of R¹, R², R³, or R⁴ is L₁X₁X₂SiR⁶R⁷R⁸; or
(ii) the quinone diimine of Formula (VII): 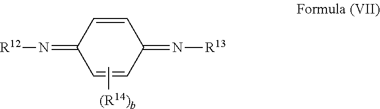
wherein
R¹² and R¹³ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 10 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each R¹⁴ is independently L₂X₃X₄SiR¹⁵R¹⁶R¹⁷;
b is 1, 2, 3, or 4;
each L₂ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₃ is —C(═O)—, —C(═O)—O—, —C(═O)—N—, or is absent;
X₄ is an optionally substituted alkylene group having from 1 to 20 carbon atoms and optionally at least one heteroatom, wherein the heteroatom is N, O, or S, or is absent;
R¹⁵, R¹⁶, and R¹⁷ are each independently —OR¹⁸, —R¹⁹, or —OC(═O)R²⁰;
R¹⁸, R¹⁹, and R²⁰ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
comprising reacting a compound of Formula (V): 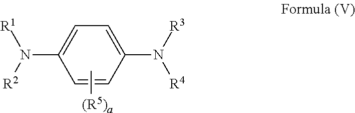
with an oxidizer and optionally a catalyst;
wherein
R¹, R², R³, and R⁴ are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S;
each R⁵ is independently L₁X₁X₂SiR⁶R⁷R⁸;
a is 1, 2, 3, or 4;
each L₁ is independently an optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
X₁ is —C(═O)—, —C(═O)—O—, —C(═O)—N—, or is absent;
X₂ is an optionally substituted alkylene group having from 1 to 20 carbon atoms and optionally at least one heteroatom, wherein the heteroatom is N, O, or S, or is absent;
R⁶, R⁷, and R⁸ are each independently —OR⁹, —R¹⁰, or —OC(═O)R¹¹;
R⁹, R¹⁰, and R¹¹ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

20. A method of making the polymer of claim 16, wherein the polymer is represented by Formula (IX): 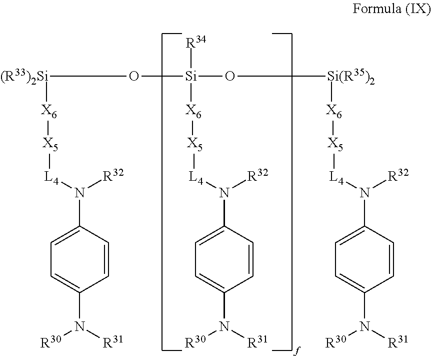
and is prepared by reacting a compound of Formula (XIII): 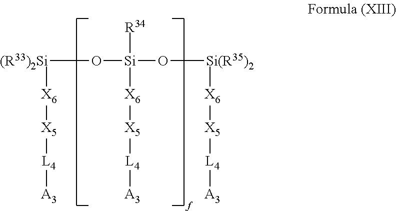
wherein
X₅ is —C(═O)—, —C(═O)—O—, —C(═O)—N—, or is absent;
X₆ is an optionally substituted alkylene group having from 1 to 20 carbon atoms and optionally at least one heteroatom, wherein the heteroatom is N, O, or S, or is absent;
each L₄ is independently optionally substituted alkylene group having from 1 to 20 carbon atoms and optionally at least one heteroatom, an optionally substituted alkenylene group having from 2 to 20 carbon atoms and optionally at least one heteroatom, an optionally substituted cycloalkylene group having from 3 to 10 carbon atoms and optionally at least one heteroatom, an optionally substituted arylene group having from 6 to 12 carbon atoms and optionally at least one heteroatom, an optionally substituted aralkylene group having from 7 to 16 carbon atoms and optionally at least one heteroatom, or is absent, wherein the heteroatom is N, O, or S;
each A₃ is —Cl, —Br, —OH, a glycidoxy group, a metacryloxypropyl group, or a isocyanatopropyl group;
R³³, R³⁴, and R³⁵ are each independently —OR³⁶, —R³⁷, or —OC(═O)R³⁸;
R³⁶, R³⁷, and R³⁸ are each independently hydrogen, an optionally substituted alkyl group having from 1 to 6 carbon atoms and optionally at least one heteroatom, an optionally substituted alkenyl group having from 2 to 6 carbon atoms and optionally at least one heteroatom, an optionally substituted cycloalkyl group having from 3 to 6 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S; and
f is an integer from 1 to 60;
with a compound of Formula (XIV): 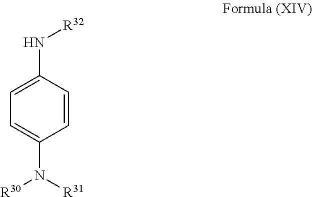
wherein
R³⁰, R³¹, and R³² are each independently hydrogen, an optionally substituted alkyl group having from 1 to 20 carbon atoms and optionally at least one heteroatom, an optionally substituted alkenyl group having from 2 to 20 carbon atoms and optionally at least one heteroatom, an optionally substituted cycloalkyl group having from 3 to 12 carbon atoms and optionally at least one heteroatom, an optionally substituted aryl group having from 6 to 12 carbon atoms and optionally at least one heteroatom, an optionally substituted aralkyl group having from 7 to 14 carbon atoms and optionally at least one heteroatom, wherein the heteroatom is N, O, or S.

21. A rubber composition comprising:
(i) the compound of claim 1;
(ii) at least one diene-based polymer; and
(iii) a vulcanizing package comprising at least one vulcanizing agent comprising sulfur and at least one accelerator.

22. The rubber composition of claim 21, further comprising silica and a silane coupling agent.

23. The rubber composition of claim 21, further comprising carbon black.

24.-25. (canceled)

26. The rubber composition of claim 21, wherein the at least one diene-based polymer is a diene-based polymer containing at least one functional group, a diene-based polymer containing no functional group, or combinations thereof.

27.-28. (canceled)

29. A rubber composition comprising:
(i) about 100 parts of rubber, where the weight of the rubber is the sum of the weights of each diene-based polymer containing at least one functional group used in the formulation and the weights of each diene-based polymer containing no functional group used in the formulation;
(ii) about 1 to about 20 parts by weight per 100 parts rubber in (i) of the composition comprising at least one compound of any one of claim 1;
(iii) about 5 to about 140 parts by weight per 100 parts rubber in (i) of silica;
(iv) about 0.1 to about 10 parts by weight per 100 parts rubber in (i) of at least one process aid; and
(v) about 0.1 to about 20 parts by weight per 100 parts rubber in (i) of a vulcanizing package comprising at least one vulcanizing agent comprising sulfur and at least one accelerator.

30. The rubber composition of claim 29, further comprising at least one antidegradant.

31.-32. (canceled)
